(19) United States
(12) Patent Application Publication
(10) Pub. No.: US 2024/0223776 A1
(43) Pub. Date: Jul. 4, 2024

(54) INTRA TEMPLATE MATCHING PREDICTION MODE FOR MOTION PREDICTION

(71) Applicant: Alibaba (China) Co., Ltd., Hangzhou (CN)

(72) Inventors: Xinwei Li, Beijing (CN); Ru-Ling Liao, Beijing (CN); Jie Chen, Beijing (CN); Yan Ye, San Diego, CA (US)

(21) Appl. No.: 18/399,650

(22) Filed: Dec. 28, 2023

Related U.S. Application Data
(60) Provisional application No. 63/436,826, filed on Jan. 3, 2023.
(60) Provisional application No. 63/449,544, filed on Mar. 2, 2023.

(51) Int. Cl. H04N 19/159; H04N 19/105; H04N 19/117; H04N 19/122; H04N 19/176; H04N 19/70

(52) U.S. Cl. CPC H04N 19/159; H04N 19/105; H04N 19/117; H04N 19/122; H04N 19/176; H04N 19/70

(57) ABSTRACT

Methods and systems implement fusion of intra TMP mode with other intra prediction modes that utilize adjacent samples, to improve prediction accuracy. A VVC-standard encoder and a VVC-standard decoder can configure one or more processors of a computing system to fuse intra TMP mode with different prediction modes, such as spatial geometric partitioning mode (“SGPM”) and combined inter and intra prediction (“CIIP”); to refine an intra TMP prediction block based on adjacent samples, such as using the method of position-dependent intra prediction combination (“PDPC”); to apply local illumination compensation (“LIC”) to refine an intra TMP prediction block; and/or to implement sub-pixel positions, including multiple, different sub-pixel positions, sub-pixel positions in combination with multi-candidate intra TMP, or flip modes in intra TMP to further improve prediction accuracy.

### RELATED APPLICATIONS

This application claims the benefit of U.S. patent application No. 63/436,826, entitled “IMPROVEMENTS TO INTRA TEMPLATE MATCHING PREDICTION MODE FOR MOTION PREDICTION” and filed Jan. 3, 2023, and claims the benefit of U.S. patent application No. 63/449,544, entitled “IMPROVEMENTS TO INTRA TEMPLATE MATCHING PREDICTION MODE FOR MOTION PREDICTION” and filed Mar. 2, 2023, each of which is expressly incorporated herein by reference in its entirety.

### BACKGROUND

In 2020, the Joint Video Experts Team (“JVET”) of the ITU-T Video Coding Expert Group (“ITU-T VCEG”) and the ISO/IEC Moving Picture Expert Group (“ISO/IEC MPEG”) published the final draft of the next-generation video codec specification, Versatile Video Coding (“VVC”). This specification further improves video coding performance over prior standards such as H.264/AVC (Advanced Video Coding) and H.265/HEVC (High Efficiency Video Coding). The JVET continues to propose additional techniques beyond the scope of the VVC standard itself, collected under the Enhanced Compression Model (“ECM”) name.

According to the VVC standard, an encoder and a decoder partition picture data into blocks, and perform motion prediction upon luma and chroma components of the blocks by selecting one among various intra prediction and inter prediction modes. Among the intra prediction modes provided by the VVC standard, intra template matching prediction (“intra TMP”) is a intra prediction mode that copies the best prediction block from the reconstructed part of the current frame, whose L-shaped template matches the current template. Intra TMP considers the non-local spatial correlation of the current frame for prediction, but does not take into account the local spatial correlation of adjacent samples of the current block.

Moreover, at time of writing, the latest draft of ECM (presented at the 32nd meeting of the JVET in October 2023 as “Algorithm description of Enhanced Compression Model 11 (ECM 11)”) includes proposals to further implement intra prediction modes, including angular intra prediction modes beyond those provided by the VVC standard. According to ECM, intra TMP is enabled not only for screen content but also for camera-captured content. For camera-captured content, which has richer textures than screen content, intra TMP may not achieve optimal results.

There is a need to further improve the capabilities of intra TMP over the functionality provided by the VVC standard and by ECM.

### BRIEF DESCRIPTION OF THE DRAWINGS

The detailed description is set forth with reference to the accompanying FIGURES. In the FIGURES, the left-most digit(s) of a reference number identifies the FIGURE in which the reference number first appears. The use of the same reference numbers in different FIGURES indicates similar or identical items or features.

FIGS. 1A and 1B illustrate example block diagrams of, respectively, an encoding process and a decoding process according to an example embodiment of the present disclosure.

FIG. 2 illustrates a reference region of IBC Mode showing available reference samples according to CTU processing order, where each block represents a 64×64 luma sample unit.

FIGS. 3A and 3B illustrate BV adjustment for a horizontal flip and a vertical flip, respectively.

FIG. 4A illustrates a search region of intra TMP. FIG. 4B illustrates templates used in alternative proposed intra TMP modes.

FIG. 5 illustrates 67 angular intra prediction modes provided by VVC.

FIGS. 6A and 6B illustrate division methods for angular intra prediction modes.

FIG. 7A illustrates neighboring samples used for refinement according to example embodiments of the present disclosure.

FIGS. 7B, 7C, and 7D illustrate interpolation of a matching template according to example embodiments of the present disclosure.

FIG. 8 illustrates the top bottom, left, and right half-pixel positions around an integer-pixel position according to example embodiments of the present disclosure.

FIG. 9 illustrates eight half-pixel positions around the integer-pixel position according to example embodiments of the present disclosure.

FIG. 10 illustrates eight quarter-pixel positions and eight half-pixel positions around an integer-pixel position according to example embodiments of the present disclosure.

FIG. 11 illustrates eight quarter-pixel positions, eight half-pixel positions, and eight three-quarters-pixel positions around an integer-pixel position according to example embodiments of the present disclosure.

FIG. 12 illustrates eight quarter-pixel positions, sixteen half-pixel positions, and twenty-four three-quarters-pixel positions around an integer-pixel position according to example embodiments of the present disclosure.

FIG. 13 illustrates four samples used in interpolation according to example embodiments of the present disclosure.

FIG. 14 illustrates an example system for implementing the processes and methods described herein for implementing intra template matching prediction mode.

### DETAILED DESCRIPTION

Systems and methods discussed herein are directed to implementing intra template matching prediction modes for motion prediction, and more specifically fusion of intra TMP mode with other intra prediction modes that utilize adjacent samples, to improve prediction accuracy.

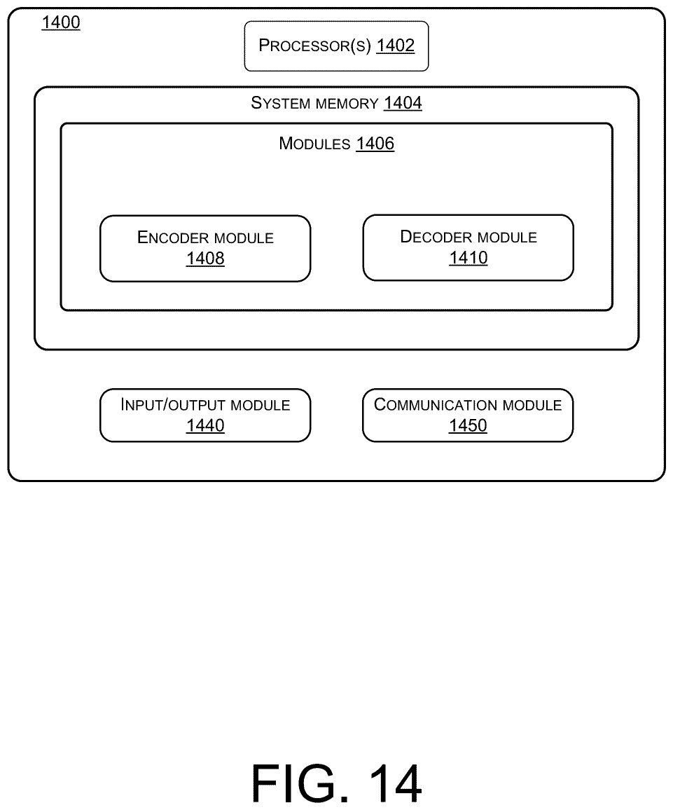

In accordance with the VVC video coding standard (the “VVC standard”) and motion prediction as described therein, a computing system includes at least one or more processors and a computer-readable storage medium communicatively coupled to the one or more processors. The computer-readable storage medium is a non-transient or non-transitory computer-readable storage medium, as defined subsequently with reference to FIG. 14, storing computer-readable instructions. At least some computer-readable instructions stored on a computer-readable storage medium are executable by one or more processors of a computing system to configure the one or more processors to perform associated operations of the computer-readable instructions, including at least operations of an encoder as described by the VVC standard, and operations of a decoder as described by the VVC standard. Some of these encoder operations and decoder operations according to the VVC standard are subsequently described in further detail, though these subsequent descriptions should not be understood as exhaustive of encoder operations and decoder operations according to the VVC standard. Subsequently, a “VVC-standard encoder” and a “VVC-standard decoder” shall describe the respective computer-readable instructions stored on a computer-readable storage medium which configure one or more processors to perform these respective operations (which can be called, by way of example, “reference implementations” of an encoder or a decoder).

Moreover, according to example embodiments of the present disclosure, a VVC-standard encoder and a VVC-standard decoder further include computer-readable instructions stored on a computer-readable storage medium which are executable by one or more processors of a computing system to configure the one or more processors to perform operations not specified by the VVC standard. A VVC-standard encoder should not be understood as limited to operations of a reference implementation of an encoder, but including further computer-readable instructions configuring one or more processors of a computing system to perform further operations as described herein. A VVC-standard decoder should not be understood as limited to operations of a reference implementation of a decoder, but including further computer-readable instructions configuring one or more processors of a computing system to perform further operations as described herein.

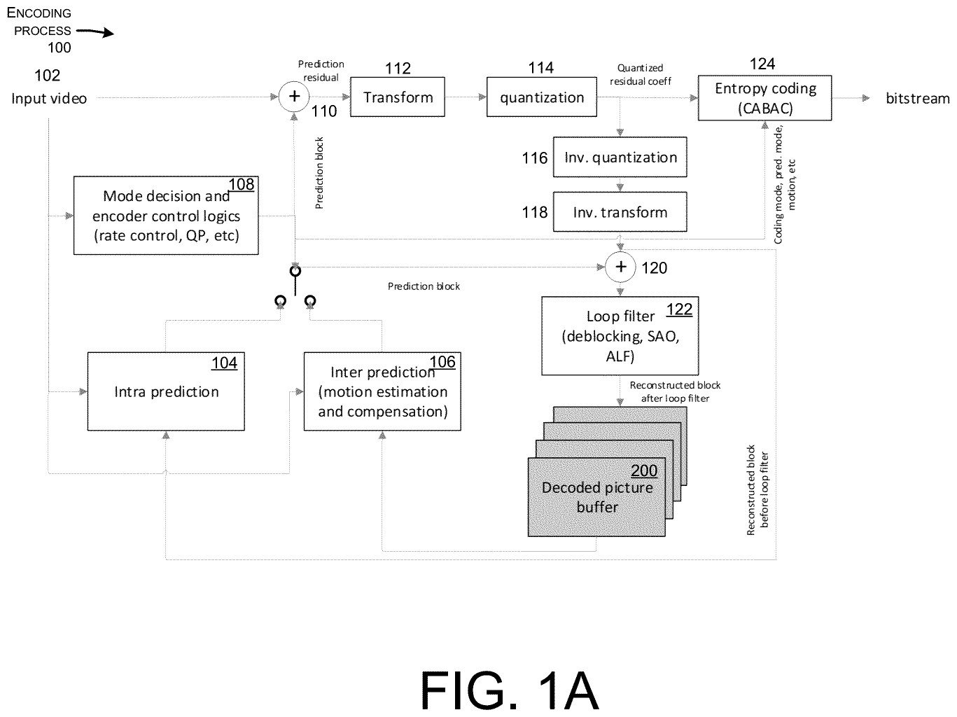

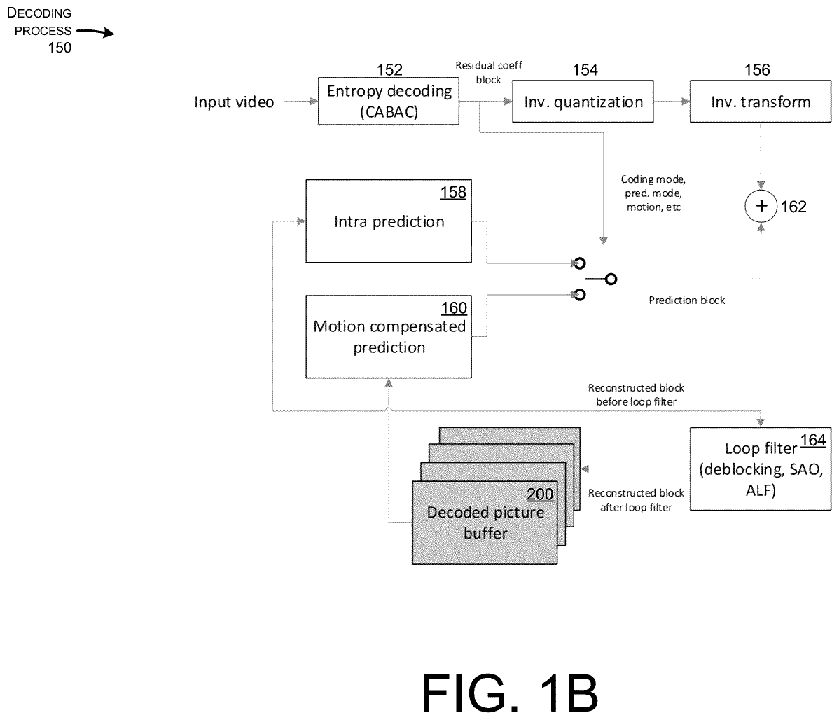

FIGS. 1A and 1B illustrate example block diagrams of, respectively, an encoding process 100 and a decoding process 150 according to an example embodiment of the present disclosure.

In an encoding process 100, a VVC-standard encoder configures one or more processors of a computing system to receive, as input, one or more input pictures from an image source 102. An input picture includes some number of pixels sampled by an image capture device, such as a photosensor array, and includes an uncompressed stream of multiple color channels (such as RGB color channels) storing color data at an original resolution of the picture, where each channel stores color data of each pixel of a picture using some number of bits. A VVC-standard encoder configures one or more processors of a computing system to store this uncompressed color data in a compressed format, wherein color data is stored at a lower resolution than the original resolution of the picture, encoded as a luma (“Y”) channel and two chroma (“U” and “V”) channels of lower resolution than the luma channel.

A VVC-standard encoder encodes a picture (a picture being encoded being called a “current picture,” as distinguished from any other picture received from an image source 102) by configuring one or more processors of a computing system to partition the original picture into units and subunits according to a partitioning structure. A VVC-standard encoder configures one or more processors of a computing system to subdivide a picture into macroblocks (“MBs”) each having dimensions of 16×16 pixels, which may be further subdivided into partitions. A VVC-standard encoder configures one or more processors of a computing system to subdivide a picture into coding tree units (“CTUs”), the luma and chroma components of which may be further subdivided into coding tree blocks (“CTBs”) which are further subdivided into coding units (“CUs”). Alternatively, a VVC-standard encoder configures one or more processors of a computing system subdivide a picture into units of N×N pixels, which may then be further subdivided into subunits. Each of these largest subdivided units of a picture may generally be referred to as a “block” for the purpose of this disclosure.

A CU is coded using one block of luma samples and two corresponding blocks of chroma samples, where pictures are not monochrome and are coded using one coding tree.

A VVC-standard encoder configures one or more processors of a computing system to subdivide a block into partitions having dimensions in multiples of 4×4 pixels. For example, a partition of a block may have dimensions of 8×4 pixels, 4×8 pixels, 8×8 pixels, 16×8 pixels, or 8×16 pixels.

By encoding color information of blocks of a picture and subdivisions thereof, rather than color information of pixels of a full-resolution original picture, a VVC-standard encoder configures one or more processors of a computing system to encode color information of a picture at a lower resolution than the input picture, storing the color information in fewer bits than the input picture.

Furthermore, a VVC-standard encoder encodes a picture by configuring one or more processors of a computing system to perform motion prediction upon blocks of a current picture. Motion prediction coding refers to storing image data of a block of a current picture (where the block of the original picture, before coding, is referred to as an “input block”) using motion information and prediction units (“PUs”), rather than pixel data, according to intra prediction 104 or inter prediction 106.

Motion information refers to data describing motion of a block structure of a picture or a unit or subunit thereof, such as motion vectors and references to blocks of a current picture or of a reference picture. PUs may refer to a unit or multiple subunits corresponding to a block structure among multiple block structures of a picture, such as an MB or a CTU, wherein blocks are partitioned based on the picture data and are coded according to the VVC standard. Motion information corresponding to a PU may describe motion prediction as encoded by a VVC-standard encoder as described herein.

A VVC-standard encoder configures one or more processors of a computing system to code motion prediction information over each block of a picture in a coding order among blocks, such as a raster scanning order wherein a first-decoded block is an uppermost and leftmost block of the picture. A block being encoded is called a “current block,” as distinguished from any other block of a same picture.

According to intra prediction 104, one or more processors of a computing system are configured to encode a block by references to motion information and PUs of one or more other blocks of the same picture. According to intra prediction coding, one or more processors of a computing system perform an intra prediction 104 (also called spatial prediction) computation by coding motion information of the current block based on spatially neighboring samples from spatially neighboring blocks of the current block.

According to inter prediction 106, one or more processors of a computing system are configured to encode a block by references to motion information and PUs of one or more other pictures. One or more processors of a computing system are configured to store one or more previously coded and decoded pictures in a reference picture buffer for the purpose of inter prediction coding; these stored pictures are called reference pictures.

One or more processors are configured to perform an inter prediction 106 (also called temporal prediction or motion compensated prediction) computation by coding motion information of the current block based on samples from one or more reference pictures. Inter prediction may further be computed according to uni-prediction or bi-prediction: in uni-prediction, only one motion vector, pointing to one reference picture, is used to generate a prediction signal for the current block. In bi-prediction, two motion vectors, each pointing to a respective reference picture, are used to generate a prediction signal of the current block.

A VVC-standard encoder configures one or more processors of a computing system to code a CU to include reference indices to identify, for reference of a VVC-standard decoder, the prediction signal(s) of the current block. One or more processors of a computing system can code a CU to include an inter prediction indicator. An inter prediction indicator indicates list 0 prediction in reference to a first reference picture list referred to as list 0, list 1 prediction in reference to a second reference picture list referred to as list 1, or bi-prediction in reference to both reference picture lists referred to as, respectively, list 0 and list 1.

In the cases of the inter prediction indicator indicating list 0 prediction or list 1 prediction, one or more processors of a computing system are configured to code a CU including a reference index referring to a reference picture of the reference picture buffer referenced by list 0 or by list 1, respectively. In the case of the inter prediction indicator indicating bi-prediction, one or more processors of a computing system are configured to code a CU including a first reference index referring to a first reference picture of the reference picture buffer referenced by list 0, and a second reference index referring to a second reference picture of the reference picture referenced by list 1.

A VVC-standard encoder configures one or more processors of a computing system to code each current block of a picture individually, outputting a prediction block for each. According to the VVC standard, a CTU can be as large as 128×128 luma samples (plus the corresponding chroma samples, depending on the chroma format). A CTU may be further partitioned into CUs according to a quad-tree, binary tree, or ternary tree. One or more processors of a computing system are configured to ultimately record coding parameter sets such as coding mode (intra mode or inter mode), motion information (reference index, motion vectors, etc.) for inter-coded blocks, and quantized residual coefficients, at syntax structures of leaf nodes of the partitioning structure.

After a prediction block is output, a VVC-standard encoder configures one or more processors of a computing system to send coding parameter sets such as coding mode (i.e., intra or inter prediction), a mode of intra prediction or a mode of inter prediction, and motion information to an entropy coder 124 (as described subsequently).

The VVC standard provides semantics for recording coding parameter sets for a CU. For example, with regard to the above-mentioned coding parameter sets, pred_mode flag for a CU is set to 0 for an inter-coded block, and is set to 1 for an intra-coded block; general merge flag for a CU is set to indicate whether merge mode is used in inter prediction of the CU; inter affine flag and cu_affine_type flag for a CU are set to indicate whether affine motion compensation is used in inter prediction of the CU; mvp_l0_flag and mvp_l1_flag are set to indicate a motion vector index in list 0 or in list 1, respectively; and ref_idx_l0 and ref_idx_l1 are set to indicate a reference picture index in list 0 or in list 1, respectively. It should be understood that the VVC standard includes semantics for recording various other information, flags, and options which are beyond the scope of the present disclosure.

A VVC-standard encoder further implements one or more mode decision and encoder control settings 108, including rate control settings. One or more processors of a computing system are configured to perform mode decision by, after intra or inter prediction, selecting an optimized prediction mode for the current block, based on the rate-distortion optimization method.

A rate control setting configures one or more processors of a computing system to assign different quantization parameters (“QPs”) to different pictures. Magnitude of a QP determines a scale over which picture information is quantized during encoding by one or more processors (as shall be subsequently described), and thus determines an extent to which the encoding process 100 discards picture information (due to information falling between steps of the scale) from MBs of the sequence during coding.

A VVC-standard encoder further implements a subtractor 110. One or more processors of a computing system are configured to perform a subtraction operation by computing a difference between an input block and a prediction block. Based on the optimized prediction mode, the prediction block is subtracted from the input block. The difference between the input block and the prediction block is called prediction residual, or “residual” for brevity.

Based on a prediction residual, a VVC-standard encoder further implements a transform 112. One or more processors of a computing system are configured to perform a transform operation on the residual by a matrix arithmetic operation to compute an array of coefficients (which can be referred to as “residual coefficients,” “transform coefficients,” and the like), thereby encoding a current block as a transform block (“TB”). Transform coefficients may refer to coefficients representing one of several spatial transformations, such as a diagonal flip, a vertical flip, or a rotation, which may be applied to a sub-block.

It should be understood that a coefficient can be stored as two components, an absolute value and a sign, as shall be described in further detail subsequently.

Sub-blocks of CUs, such as PUs and TBs, can be arranged in any combination of sub-block dimensions as described above. A VVC-standard encoder configures one or more processors of a computing system to subdivide a CU into a residual quadtree (“RQT”), a hierarchical structure of TBs. The RQT provides an order for motion prediction and residual coding over sub-blocks of each level and recursively down each level of the RQT.

A VVC-standard encoder further implements a quantization 114. One or more processors of a computing system are configured to perform a quantization operation on the residual coefficients by a matrix arithmetic operation, based on a quantization matrix and the QP as assigned above. Residual coefficients falling within an interval are kept, and residual coefficients falling outside the interval step are discarded.

A VVC-standard encoder further implements an inverse quantization 116 and an inverse transform 118. One or more processors of a computing system are configured to perform an inverse quantization operation and an inverse transform operation on the quantized residual coefficients, by matrix arithmetic operations which are the inverse of the quantization operation and transform operation as described above. The inverse quantization operation and the inverse transform operation yield a reconstructed residual.

A VVC-standard encoder further implements an adder 120. One or more processors of a computing system are configured to perform an addition operation by adding a prediction block and a reconstructed residual, outputting a reconstructed block.

A VVC-standard encoder further implements a loop filter 122. One or more processors of a computing system are configured to apply a loop filter, such as a deblocking filter, a sample adaptive offset (“SAO”) filter, and adaptive loop filter (“ALF”) to a reconstructed block, outputting a filtered reconstructed block.

A VVC-standard encoder further configures one or more processors of a computing system to output a filtered reconstructed block to a decoded picture buffer (“DPB”) 200. A DPB 200 stores reconstructed pictures which are used by one or more processors of a computing system as reference pictures in coding pictures other than the current picture, as described above with reference to inter prediction.

A VVC-standard encoder further implements an entropy coder 124. One or more processors of a computing system are configured to perform entropy coding, wherein, according to the Context-Sensitive Binary Arithmetic Codec (“CABAC”), symbols making up quantized residual coefficients are coded by mappings to binary strings (subsequently “bins”), which can be transmitted in an output bitstream at a compressed bitrate. The symbols of the quantized residual coefficients which are coded include absolute values of the residual coefficients (these absolute values being subsequently referred to as “residual coefficient levels”).

Thus, the entropy coder configures one or more processors of a computing system to code residual coefficient levels of a block; bypass coding of residual coefficient signs and record the residual coefficient signs with the coded block; record coding parameter sets such as coding mode, a mode of intra prediction or a mode of inter prediction, and motion information coded in syntax structures of a coded block (such as a picture parameter set (“PPS”) found in a picture header, as well as a sequence parameter set (“SPS”) found in a sequence of multiple pictures); and output the coded block.

A VVC-standard encoder configures one or more processors of a computing system to output a coded picture, made up of coded blocks from the entropy coder 124. The coded picture is output to a transmission buffer, where it is ultimately packed into a bitstream for output from the VVC-standard encoder. The bitstream is written by one or more processors of a computing system to a non-transient or non-transitory computer-readable storage medium of the computing system, for transmission.

In a decoding process 150, a VVC-standard decoder configures one or more processors of a computing system to receive, as input, one or more coded pictures from a bitstream.

A VVC-standard decoder implements an entropy decoder 152. One or more processors of a computing system are configured to perform entropy decoding, wherein, according to CABAC, bins are decoded by reversing the mappings of symbols to bins, thereby recovering the entropy-coded quantized residual coefficients. The entropy decoder 152 outputs the quantized residual coefficients, outputs the coding-bypassed residual coefficient signs, and also outputs the syntax structures such as a PPS and a SPS.

A VVC-standard decoder further implements an inverse quantization 154 and an inverse transform 156. One or more processors of a computing system are configured to perform an inverse quantization operation and an inverse transform operation on the decoded quantized residual coefficients, by matrix arithmetic operations which are the inverse of the quantization operation and transform operation as described above. The inverse quantization operation and the inverse transform operation yield a reconstructed residual.

Furthermore, based on coding parameter sets recorded in syntax structures such as PPS and a SPS by the entropy coder 124 (or, alternatively, received by out-of-band transmission or coded into the decoder), and a coding mode included in the coding parameter sets, the VVC-standard decoder determines whether to apply intra prediction 156 (i.e., spatial prediction) or to apply motion compensated prediction 158 (i.e., temporal prediction) to the reconstructed residual.

In the event that the coding parameter sets specify intra prediction, the VVC-standard decoder configures one or more processors of a computing system to perform intra prediction 158 using prediction information specified in the coding parameter sets. The intra prediction 158 thereby generates a prediction signal.

In the event that the coding parameter sets specify inter prediction, the VVC-standard decoder configures one or more processors of a computing system to perform motion compensated prediction 160 using a reference picture from a DPB 200. The motion compensated prediction 160 thereby generates a prediction signal.

A VVC-standard decoder further implements an adder 162. The adder 162 configures one or more processors of a computing system to perform an addition operation on the reconstructed residuals and the prediction signal, thereby outputting a reconstructed block.

A VVC-standard decoder further implements a loop filter 164. One or more processors of a computing system are configured to apply a loop filter, such as a deblocking filter, a SAO filter, and ALF to a reconstructed block, outputting a filtered reconstructed block.

A VVC-standard decoder further configures one or more processors of a computing system to output a filtered reconstructed block to the DPB 200. As described above, a DPB 200 stores reconstructed pictures which are used by one or more processors of a computing system as reference pictures in coding pictures other than the current picture, as described above with reference to motion compensated prediction.

A VVC-standard decoder further configures one or more processors of a computing system to output reconstructed pictures from the DPB to a user-viewable display of a computing system, such as a television display, a personal computing monitor, a smartphone display, or a tablet display.

Therefore, as illustrated by an encoding process 100 and a decoding process 150 as described above, a VVC-standard encoder and a VVC-standard decoder each implements motion prediction coding in accordance with the VVC specification. A VVC-standard encoder and a VVC-standard decoder each configures one or more processors of a computing system to generate a reconstructed picture based on a previous reconstructed picture of a DPB according to motion compensated prediction as described by the VVC standard, wherein the previous reconstructed picture serves as a reference picture in motion compensated prediction as described herein.

According to the VVC standard, coding trees are configured to provide separate block tree structures for the luma and chroma components of a picture. A CTU can include three CTBs, these in turn including one luma CTB (“Y”) and two chroma CTBs (“Cb” and “Cr”).

For P slices and B slices, luma and chroma CTBs of one CTU are configured to share a common coding tree structure. However, for I slices, the luma and chroma CTBs can be configured having separate block tree structures. Given a coding tree configured for separate block trees, a luma CTB is partitioned into CUs by a first coding tree structure, and chroma CTBs are partitioned into chroma CUs by a second coding tree structure.

In other words, while a CU of an I slice may contain a coding block of the luma component or coding blocks of two chroma components, a CU in a P or B slice contains coding blocks of all three color components (unless the video is monochrome).

According to the VVC standard, the luma component can be predicted by multiple intra prediction modes. These include a Planar intra prediction mode; a DC intra prediction mode; an angular intra prediction mode; Multiple Reference Line (“MRL”) prediction modes; Intra Sub-partition (“ISP”) modes; and Matrix-based Intra Prediction (“MIP”) modes. These modes are described in further detail subsequently.

Angular intra prediction is a directional intra prediction method, which is extended from a prior implementation according to the HEVC standard. To capture the arbitrary edge directions presented in natural video, the VVC standard extends the number of angular intra prediction modes from 33 (as used in HEVC) to 65.

Furthermore, according to the VVC standard, intra block copy (“IBC”) mode is implemented as a block level coding mode. Herein, a VVC-standard encoder configures one or more processors of a computing system to perform block matching (“BM”) to find the optimal block vector (or motion vector) for each CU. A block vector indicates the displacement from the current block to a reference block, which is already reconstructed inside the current picture. The luma block vector of an IBC-coded CU is in integer precision. The chroma block vector rounds to integer precision as well.

When combined with Adaptive Motion Vector Resolution (“AMVR”), IBC mode can switch between 1-pel and 4-pel motion vector precisions. An IBC-coded CU is treated as the third prediction mode other than intra or inter prediction modes. The IBC mode is applicable to the CUs with both width and height smaller than or equal to 64 luma samples.

At the encoder side, hash-based motion estimation is performed for IBC. The encoder performs RD check for blocks with either width or height no larger than 16 luma samples. For non-merge mode, the block vector search is performed using hash-based search first. If hash search does not return any valid candidate, block matching-based local search will be performed.

In a hash-based search, hash key matching (32-bit CRC) between the current block and a reference block is extended to all allowed block sizes. The hash key calculation for every position in the current picture is based on 4×4 subblocks. For the current block of a larger size, a hash key is determined to match that of the reference block when all the hash keys of all 4×4 subblocks match the hash keys in the corresponding reference locations. If hash keys of multiple reference blocks are found to match that of the current block, the block vector costs of each matched reference are calculated and the one with the minimum cost is selected.

In a block matching search, the search range is set to cover both the previous and current CTUs.

IBC mode is signaled in a bitstream with a CU-level flag and it can be signaled as IBC adaptive motion vector prediction (“AMVP”) mode or IBC skip/merge mode as follows:

IBC skip/merge mode: a merge candidate index is signaled to indicate which of the block vectors in the list from neighboring candidate IBC coded blocks is used to predict the current block. The merge list consists of spatial, HMVP, and pairwise candidates.

IBC AMVP mode: block vector difference is coded in the same way as a motion vector difference. The block vector prediction method uses two candidates as predictors, one from left neighbor and one from above neighbor (if IBC coded). When either neighbor is not available, a default block vector will be used as a predictor. A flag is signaled to indicate the block vector predictor index.

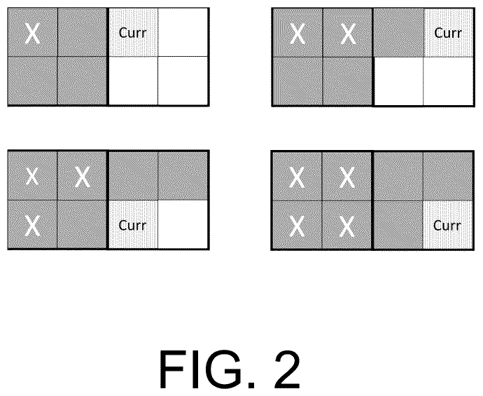

To reduce memory consumption and decoder complexity, the IBC in VVC allows only the reconstructed portion of the predefined area including the region of current CTU and some region of the left CTU. FIG. 2 illustrates a reference region of IBC Mode showing available reference samples according to CTU processing order, where each block represents 64×64 luma sample unit.

Depending on the location of the current coding CU location within the current CTU, the following applies:

If a current block falls into the top-left 64×64 block of the current CTU, then in addition to the already reconstructed samples in the current CTU, it can also refer to the reference samples in the bottom-right 64×64 blocks of the left CTU, using CPR mode. The current block can also refer to the reference samples in the bottom-left 64×64 block of the left CTU and the reference samples in the top-right 64×64 block of the left CTU, using CPR mode.

If a current block falls into the top-right 64×64 block of the current CTU, then in addition to the already reconstructed samples in the current CTU, if luma location (0, 64) relative to the current CTU has not yet been reconstructed, the current block can also refer to the reference samples in the bottom-left 64×64 block and bottom-right 64×64 block of the left CTU, using CPR mode; otherwise, the current block can also refer to reference samples in bottom-right 64×64 block of the left CTU.

If a current block falls into the bottom-left 64×64 block of the current CTU, then in addition to the already reconstructed samples in the current CTU, if luma location (64, 0) relative to the current CTU has not yet been reconstructed, the current block can also refer to the reference samples in the top-right 64×64 block and bottom-right 64×64 block of the left CTU, using CPR mode. Otherwise, the current block can also refer to the reference samples in the bottom-right 64×64 block of the left CTU, using CPR mode.

If a current block falls into the bottom-right 64×64 block of the current CTU, it can only refer to the already reconstructed samples in the current CTU, using CPR mode.

These above-referenced restrictions allow the IBC mode to be implemented using local on-chip memory for hardware implementations.

Furthermore, according to ECM, a Reconstruction-Reordered IBC (RR-IBC) mode can be applied for IBC coded blocks. When RR-IBC is applied, the samples in a reconstruction block are flipped according to a flip type of the current block. At the encoder side, the original block is flipped before motion search and residual calculation, while the prediction block is derived without flipping. At the decoder side, the reconstruction block is flipped back to restore the original block.

Two flip methods, horizontal flip and vertical flip, are supported for RR-IBC coded blocks. A syntax flag is firstly signaled for an IBC AMVP coded block, indicating whether the reconstruction is flipped; if it is flipped, another flag is further signaled specifying the flip type. For IBC merge, the flip type is inherited from neighboring blocks, without syntax signaling. Considering the horizontal or vertical symmetry, the current block and the reference block are normally aligned horizontally or vertically. Therefore, when a horizontal flip is applied, the vertical component of the BV is not signaled and is inferred to be equal to 0. Similarly, the horizontal component of the BV is not signaled and is inferred to be equal to 0 when a vertical flip is applied.

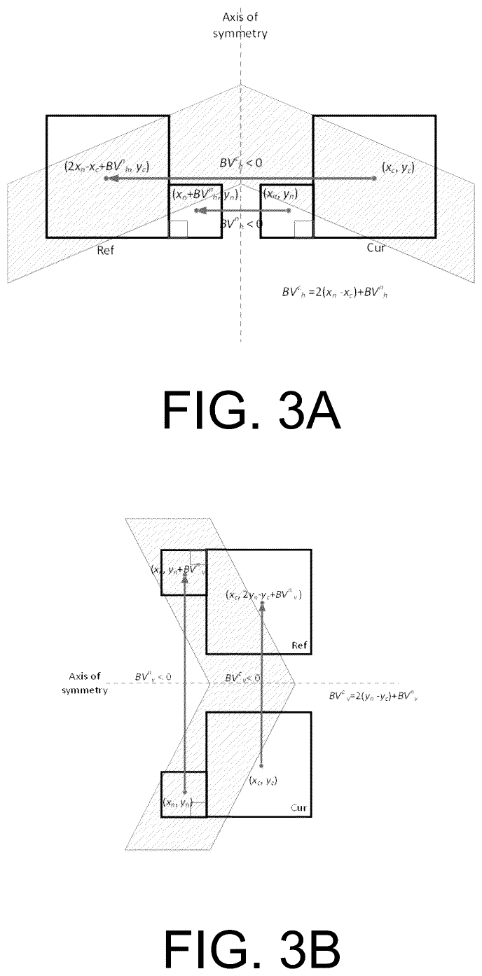

To better utilize the symmetry property, a flip-aware BV adjustment approach is applied to refine the block vector candidate. For example, as shown in FIGS. 3A and 3B, (x_{nbr}, y_{nbr}) and (x_{cur}, y_{cur}) represent the coordinates of the center sample of the neighboring block and the current block, respectively, BV^{nbr} and BV^{cur} denotes the BV of the neighboring block and the current block, respectively. Instead of directly inheriting the BV from a neighboring block, the horizontal component of BV^{cur} is calculated by adding a motion shift to the horizontal component of BV^{nbr} (denoted as BV^{nbr}ₕ) in case that the neighboring block is coded with a horizontal flip, i.e., BV^{cur}ₕ=2(x_{nbr}−x_{cur})+BV^{nbr}ₕ. Similarly, the vertical component of BV^{cur} is calculated by adding a motion shift to the vertical component of BV^{nbr} (denoted as BV^{nbr}ᵥ) in case that the neighboring block is coded with a vertical flip, i.e., BV^{cur}ᵥ=2(y_{nbr}−y_{cur})+BV^{nbr}ᵥ.

Furthermore, the VVC standard and ECM further provide intra template matching prediction (intra TMP) mode. Herein, a VVC-standard encoder configures one or more processors of a computing system to derive the best prediction block from the reconstructed part of the current frame whose L-shaped template matches the current template. For a predefined search range, the encoder searches for the most similar template to the current template in a reconstructed part of the current frame, determines a matching block based on the matched template, and uses the matching block as a prediction block. The encoder then signals the usage of this mode, and the same prediction operation is performed at the decoder side.

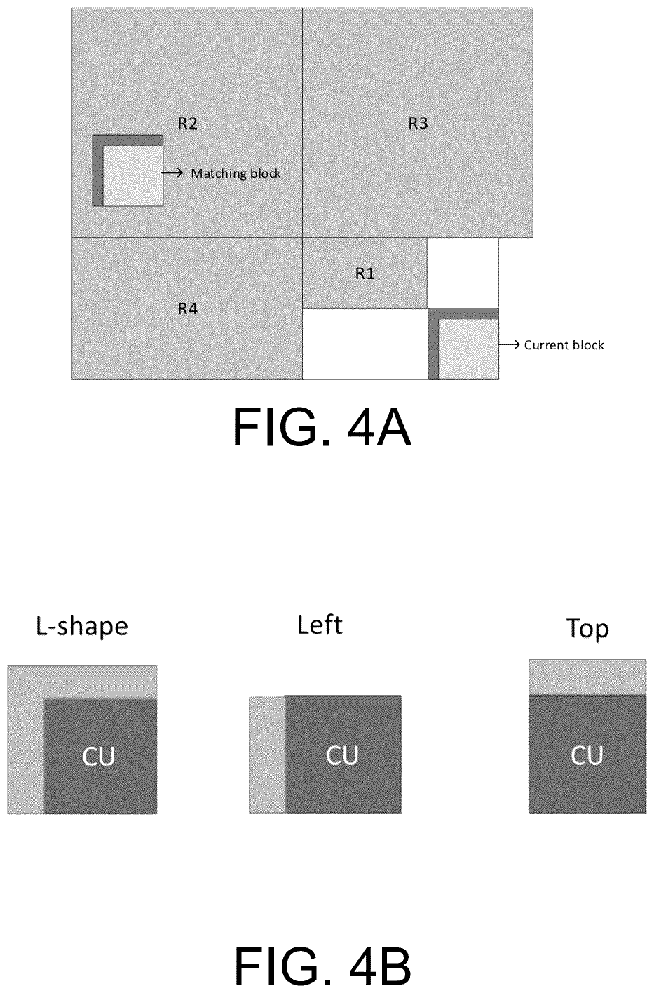

The prediction signal is generated by matching a template of the current block, i.e., the L-shaped causal neighbor of the current block, with another template in a predefined search region. In some disclosed embodiments, the predefined search region is as shown in FIG. 4A consisting of:
R1: current CTU
R2: top-left CTU
R3: above CTU
R4: left CTU

A template of a current block is matched to a template in a searched region by comparing a cost function. Sum of absolute differences (“SAD”) is used as a cost function. Within each search region, the decoder searches for the template that has least SAD with respect to the template of the current block, and uses the block corresponding to the matched template (the “matching block”) as a prediction block.

The dimensions of all regions (SearchRange_w, SearchRange_h) are set proportional to the block dimension (i, h) to have a fixed number of SAD comparisons per pixel. That is:

$$\begin{matrix}Search {Range}_{w} = a * w \\ Search Range\_h = a * h\end{matrix}$$

where a is a constant that controls the gain/complexity trade-off. In practice, a is equal to 5.

In order to speed-up the template matching, the search regions (R1 to R4) are sub-sampled by a factor of 2. This reduces the template-matching searches by a factor of 4. After finding the best match, a refinement process is performed in which another template matching search is performed around the best match with a reduced search range. The refined search range is defined as min(w, h)/2, where w and h are the current CU width and height.

Furthermore, a multi-candidate intra TMP method is proposed for the VVC standard and ECM. There are usually several blocks that are similar to the current block, having comparable respective template matching cost. Therefore, rather than selecting only one matching block which has the least SAD, intra TMP can alternatively be implemented with multiple prediction block candidates. A candidate list is constructed and the candidate matching blocks are ranked in ascending order of their template matching costs. Thereafter, an index is signaled in the bitstream to indicate which prediction block candidate is actually used for the current block.

Alternatively, according to an intra TMP fusion method proposed for the VVC standard and ECM, the N candidate matching blocks corresponding to the N smallest template matching cost are fused to derive a prediction block for the current block.

Alternatively, according to an intra TMP filter method proposed for the VVC standard and ECM, a linear filter model is applied to intra TMP prediction. A 6-tap linear filter consists of 5 spatial luma samples in the matching block and a bias term. Filter coefficients are derived for each block using the regression based the minimized MSE on samples between the matching template and current template.

Alternatively to or in addition to intra TMP mode based on an L-shaped template (left and above templates), an intra TMP mode using only a left template, and an intra TMP mode using only an above template, as respectively illustrated in FIG. 4B, are proposed.

However, predicted sample values of intra TMP-coded blocks may be less accurate due to the following limitations:

Intra TMP only considers the non-local spatial correlation of the current frame for prediction, but does not take into account the local spatial correlation of adjacent samples of the current block.

Even within the same frame, there may be a change in illumination.

In ECM, intra TMP is enabled not only for screen content but also for camera-captured content. For camera-captured content, which has richer textures than screen content, the limitation of intra TMP to integer-pixel positions may not achieve optimal results.

Therefore, example embodiments of the present disclosure provide fusion of intra TMP mode with other intra prediction modes that utilize adjacent samples, to improve prediction accuracy. According to example embodiments of the present disclosure, intra TMP mode is fused with different prediction modes, such as spatial geometric partitioning mode (“SGPM”) and combined inter and intra prediction (“CIIP”). According to further example embodiments of the present disclosure, an intra TMP prediction block is refined based on adjacent samples, such as using the method of position-dependent intra prediction combination (“PDPC”). According to further example embodiments of the present disclosure, LIC is applied to refine an intra TMP prediction block. According to further example embodiments of the present disclosure, sub-pixel positions are implemented in intra TMP to further improve prediction accuracy.

According to example embodiments of the present disclosure, intra TMP mode is fused with an intra prediction mode. The intra prediction modes enabled for the luma component in VVC are the Planar, DC, angular intra prediction modes, Multiple Reference Line (“MRL”) prediction modes, Intra Sub-partition (“ISP”) modes, and Matrix-based Intra Prediction (“MIP”) modes.

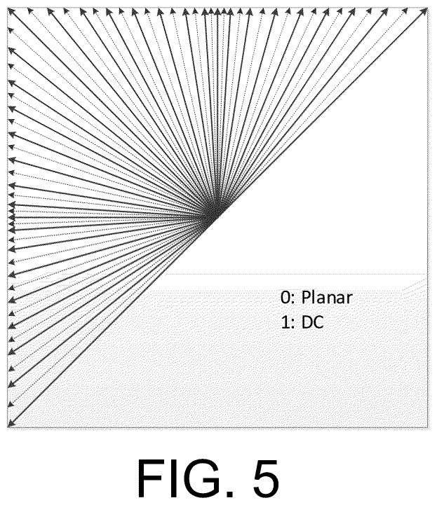

Angular intra prediction is a directional intra prediction method that is supported in HEVC and that is also part of VVC. To capture the arbitrary edge directions presented in natural video, the number of angular intra prediction modes in VVC is extended from 33, as used in HEVC, to 65. The new angular intra prediction modes not in HEVC are depicted as dotted arrows in FIG. 5.

As in HEVC, two non-angular intra prediction modes, DC and planar modes are also supported in VVC. The DC intra prediction mode uses the mean sample value of the reference samples to the block for prediction generation. VVC uses the reference samples only along the longer side of a rectangular block to calculate the mean value, while for square blocks the reference samples from both left and above sides are used. In the Planar mode, the predicted sample values are obtained as a weighted average of 4 reference sample values. Here, the reference samples in the same row or column as the current sample and the reference samples on the bottom-left and on the top-right position with respect to the block are used.

In VVC, the results of intra prediction of DC, planar and several angular modes are further modified by a position dependent intra prediction combination (“PDPC”) method. PDPC is applied to the following intra modes without signaling: planar, DC, intra angles less than or equal to horizontal, and intra angles greater than or equal to vertical and less than or equal to index 80.

The prediction sample pred(x′, y′) is predicted using an intra prediction mode (DC, planar, angular) and a linear combination of reference samples according to the following equation:

$$pred ( {x}^{′} , {y}^{′} ) = Clip ( 0 , ( 1 << Bit Depth ) - 1 , ( wL \times R - 1 , {y}^{′} + wT \times {Rx}^{′} , - 1 + ( 64 - wL - wT ) \times pre d ( {x}^{′} , {y}^{′} ) + 32 ) >> 6 )$$

where R_{x′, -1}, R_{-1,y′} represent the reference samples located at the upper and left boundaries of current sample (x, y), respectively.

PDPC processes for DC and Planar modes are identical. For angular modes, if the current angular mode is HOR_IDX or VER_IDX, left or upper reference samples are not used, respectively. The PDPC weights and scale factors are dependent on prediction modes and the block sizes. PDPC is applied to the block with both width and height greater than or equal to 4.

For MRL modes, in addition to the directly adjacent line of neighboring samples, one of the two non-adjacent reference lines can comprise the input for intra prediction in VVC.

The ISP divides luma intra-predicted blocks vertically or horizontally into 2 or 4 sub-partitions depending on the block size. For each sub-partition, the prediction and transform coding operations are performed separately, but the intra prediction mode is shared across all sub-partitions.

Furthermore, MIP is a newly added intra prediction technique to VVC. For predicting the samples of a block of width W and height H, MIP takes one line of H reconstructed neighboring boundary samples left of the block and one line of W reconstructed neighboring boundary samples above the block as input. The generation of the prediction signal is based on three steps: a down-sampling of the reference samples, a matrix vector multiplication, and an up-sampling of the result by linear interpolation.

ECM further proposes luma intra prediction modes: Decoder-side intra mode derivation (“DIMD”) mode and Template-based intra mode derivation (“TIMD”) mode. When DIMD is applied, two intra prediction modes from 65 angular modes are derived from the reconstructed neighbor samples, and those two predictors are combined with the Planar mode predictor with the weights derived from the gradients. When TIMD is applied, for each intra prediction mode in a list, the SATD between the predicted and reconstructed samples of a template is calculated. First two intra prediction modes with the minimum SATD are selected and fused with the weights derived from the SATD.

According to example embodiments of the present disclosure, a VVC-standard encoder and a VVC-standard decoder configure one or more processors of a computing system to fuse the prediction of the intra TMP mode and the prediction of another intra prediction mode (which can be any intra prediction mode as described above), as shown below to generate a motion prediction:

$$pred ( i , j ) = {w}_{0} \cdot {pred}_{i n t r a T M P} ( i , j ) + {w}_{1} \cdot {pred}_{i n t r a} ( i , j )$$

where pred_{intraTMP}(i, j) represents the predicted value of the current sample generated by intra TMP mode; predᵢₙₜᵣₐ(i, j) represents the predicted value of the current sample generated by another intra prediction mode; pred(i, j) represents the final predicted value of the current sample by fusing the intra TMP mode and the intra prediction mode; (i, j) is the coordinate of the current sample in the current block; w₀ and w₁ are two weights and the sum of the two weight should be equal to 1.

The intra prediction mode used to generate predᵢₙₜᵣₐ(i, j) can be a predefined intra prediction mode. By way of example, the intra prediction mode is planar mode. By way of another example, the intra prediction mode is DC mode. By way of another example, the intra prediction mode is an angular mode derived by DIMD method, i.e., derived from the gradient information of adjacent samples. By way of another example, the intra prediction mode is an intra prediction mode derived by TIMD method, i.e., derived from the template.

The intra prediction mode used to generate predᵢₙₜᵣₐ(i, j) can be indicated by a syntax element signaled in the bitstream. For example, for a block that is indicted to be predicted by the fusion of the intra TMP mode and another intra prediction mode, an intra prediction mode list, which contains several intra prediction modes among the planar, DC and the 65 angular modes, can be constructed. An index is signaled in the bitstream to indicate which intra prediction mode is selected.

The two weights w₀ and w₁ can be two predefined values: for example, the value of w₀ can be equal to 0.5 and the value of w₁ can be equal to 0.5. The two weights w₀ and w₁ can be determined based on the intra prediction mode of the neighboring blocks, for example, when there are more blocks with intra TMP mode coded in the neighboring blocks, the value of w₀ is larger; when there are fewer blocks with intra TMP mode coded in the neighboring blocks, the value of w₁ is larger. The two weights w₀ and w₁ can also be indicated by a syntax element signaled in the bitstream. For example, a list of the two weights is constructed and an index of the selected weights is signaled in the bitstream.

The usage of the fusion of intra TMP mode and another intra prediction mode for a block can be indicated by a flag signaled in the bitstream. Specifically, for a block, when there is a flag in the bitstream indicating that intra TMP mode is used for prediction, another flag is further signaled in the bitstream to indicate whether to fuse with another intra prediction mode. In some embodiments, there is no additional flag to indicate the fusion; that is, for a block, when there is a flag in the bitstream indicating that intra TMP mode is used for prediction, it is always fused with another intra prediction mode.

In some embodiments, for a block predicted by the fusion of the intra TMP mode and another intra prediction mode, the template matching process is also modified. In the original intra TMP template matching, the SAD value between the reconstructed values of the template of the current block and the reconstructed values of the matched template is calculated to find the matching block. In contrast, according to example embodiments of the present disclosure, for a block predicted by the fusion mode, the intra prediction mode is used to predict the template of the current block by its neighboring samples, and the predicted sample values of the template will also affect the process of template matching. By way of example, when performing template matching, the reconstructed values of the matched template is fused with the predicted sample values of the template of the current block obtained by using the intra prediction mode, and then the SAD value between the fused values and the reconstructed values of the template of the current block is calculated for template matching. By way of another example, when performing template matching, the reconstructed values of the template of the current block is subtracted from the predicted sample values obtained by using the intra prediction mode, and then the SAD value between the modified values and the reconstructed values of the matched template is calculated for template matching.

According to example embodiments of the present disclosure, a VVC-standard encoder and a VVC-standard decoder configure one or more processors of a computing system to fuse intra TMP mode with spatial geometric partitioning mode (“SGPM”). In VVC, a SGPM mode is supported for inter prediction. The geometric partitioning mode is signaled using a CU-level flag as one kind of merge mode, with other merge modes including the regular merge mode, the MMVD mode, the CIIP mode and the subblock merge mode. In total, 64 partitions are supported by geometric partitioning mode for each possible CU size.

When this mode is used, a CU is split into two parts by a geometrically located straight line. The location of the splitting line is mathematically derived from the angle and offset parameters of a specific partition. Each part of a geometric partition in the CU is inter-predicted using its own motion; only uni-prediction is allowed for each partition, that is, each part has one motion vector and one reference index. The uni-prediction motion constraint is applied to ensure that same as the conventional bi-prediction, only two motion compensated prediction are needed for each CU. After predicting each of part of the geometric partition, the sample values along the geometric partition edge are adjusted using a blending processing with adaptive weights. This is the prediction signal for the whole CU, and transform and quantization process will be applied to the whole CU as in other prediction modes.

A spatial GPM method is adopted in ECM, where which makes use of geometric partitioning mode (GPM) in intra-prediction. This new intra-coding tool partitions a coding block into two parts and generates two corresponding intra-prediction modes. To efficiently express the partition and associated prediction information in the bitstream, this method employs a template-reordered candidate list, where each candidate in the list comprises a combination of the partition mode and two intra prediction modes, and only signals the candidate index.

For each partition mode, a VVC-standard encoder and a VVC-standard decoder derive an IPM list for each part. The IPM list size is 3. The IPM list is derived as follows: the TIMD mode, the DIMD mode, the intra modes of the neighboring blocks. Possible combinations of one geometric partition mode and two intra prediction modes are ranked in ascending order based on their SAD between the prediction and reconstruction of the template. The weights in the template are either 1 or 0 according to the partition mode. The template size is set equal to 1, i.e. the height of the upper template part is 1 and the width of the left template part is 1. The length of the candidate list of combinations is set equal to 16.

According to example embodiments of the present disclosure, a VVC-standard encoder and a VVC-standard decoder configure one or more processors of a computing system to include intra TMP mode in the IPM list of the SGPM so that the intra TMP mode can be fused with another intra prediction mode in a block which is geometric partitioned.

By way of example, the intra TMP mode is always included in the IPM list of the SGPM. For example, the number of the intra prediction mode in the IPM list is extend from 3 to 4, the first 3 modes are constructed in the original way and the fourth mode is set to intra TMP mode.

By way of another example, the intra TMP mode is included in the IPM list of the SGPM when at least one of the neighboring blocks is intra TMP mode coded.

By way of another example, the intra TMP mode is included in the IPM list of the SGPM when at least one of the neighboring blocks is intra TMP mode coded and the block vector of the neighboring block will be used for predicting the current block. Specifically, when constructing the IPM list in SGPM for the current block, neighboring blocks will be traversed in a specific order, and the block vector that indicates the position of the matching block of the first intra TMP coded neighboring block traversed will be stored. Then when predicting the current block with the intra TMP mode, the stored block vector is used rather than doing the template matching to find another block vector for the current block.

According to example embodiments of the present disclosure, a VVC-standard encoder and a VVC-standard decoder configure one or more processors of a computing system to fuse intra TMP mode with combined inter and intra prediction mode (“CIIP”). According to VVC, when a CU is coded in merge mode, if the CU contains at least 64 luma samples (that is, CU width times CU height is equal to or larger than 64), and if both CU width and CU height are less than 128 luma samples, an additional flag is signaled to indicate if the combined inter/intra prediction (CIIP) mode is applied to the current CU. As its name indicates, the CIIP prediction combines an inter prediction signal with an intra prediction signal. The inter prediction signal in the CIIP mode P inter is derived using the same inter prediction process applied to regular merge mode; and the intra prediction signal P intra is derived following the regular intra prediction process with the planar mode. Then, the intra and inter prediction signals are combined using weighted averaging, where the weight value is calculated depending on the coding modes of the upper and left neighbouring blocks as follows:
If the upper neighbor is available and intra coded, then set isIntraTop to 1, otherwise set isIntraTop to 0;
If the left neighbor is available and intra coded, then set isIntraLeft to 1, otherwise set isIntraLeft to 0;
If (isIntraLeft+isIntraTop) is equal to 2, then wt is set to 3;
Otherwise, if (isIntraLeft+isIntraTop) is equal to 1, then wt is set to 2;
Otherwise, set wt to 1.

The CIIP prediction is computed as follows:

$${P}_{C I I P} = ( ( 4 - w t ) * {P}_{i n t e r} + w t * {P}_{i n t r a} + 2 ) ≫ 2$$

According to ECM, the TIMD derivation method is used to derive the intra prediction mode in CIIP. Specifically, the intra prediction mode with the smallest SATD values in the TIMD mode list is selected and mapped to one of the 67 regular intra prediction modes.

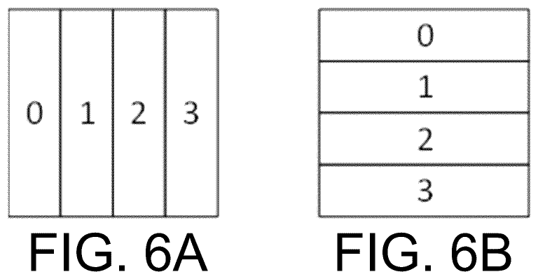

In addition, it is also proposed to modify the weights if the derived intra prediction mode is an angular mode. For near-horizontal modes (2<=angular mode index <34), the current block is vertically divided as shown in FIG. 6A; for near-vertical modes (34<=angular mode index <=66), the current block is horizontally divided as shown in FIG. 6B.

The (wIntra, wInter) for different sub-blocks are shown in Table 1 below.

| Sub-block index | (wIntra, wInter) |
|---|---|
| 0 | (6, 2) |
| 1 | (5, 3) |
| 2 | (3, 5) |
| 3 | (2, 6) |

According to example embodiments of the present disclosure, a VVC-standard encoder and a VVC-standard decoder configure one or more processors of a computing system to include intra TMP mode in CIIP mode. The CIIP prediction can combine an inter prediction signal with an intra prediction signal. By way of example, the CIIP prediction can also combine an intra TMP prediction signal with another intra prediction signal. By way of another example, the CIIP prediction can also combine an intra TMP prediction signal with an inter prediction signal.

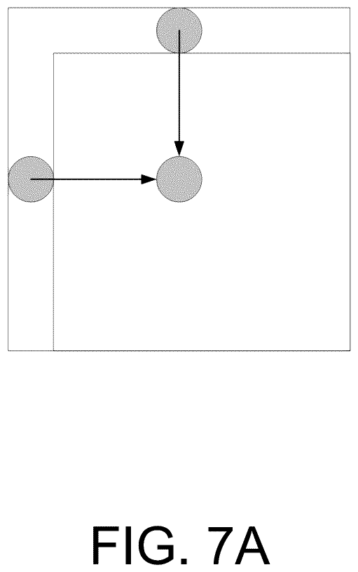

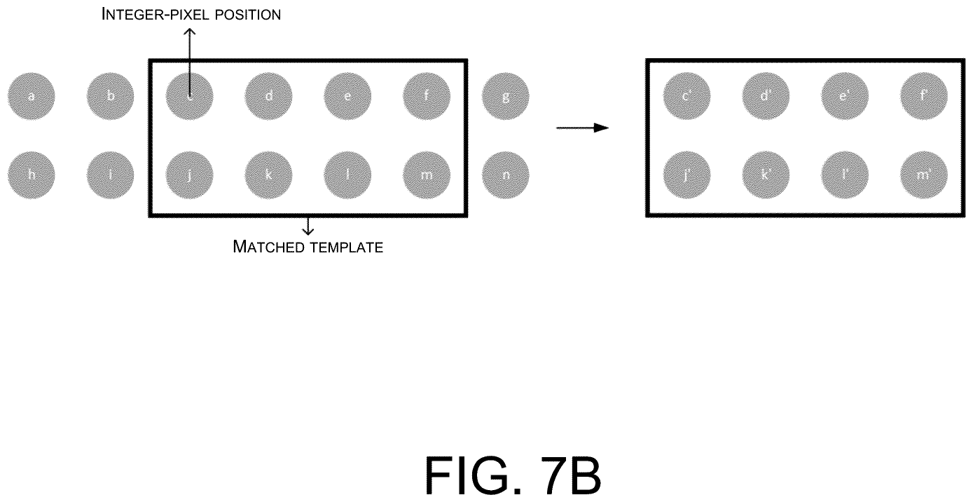

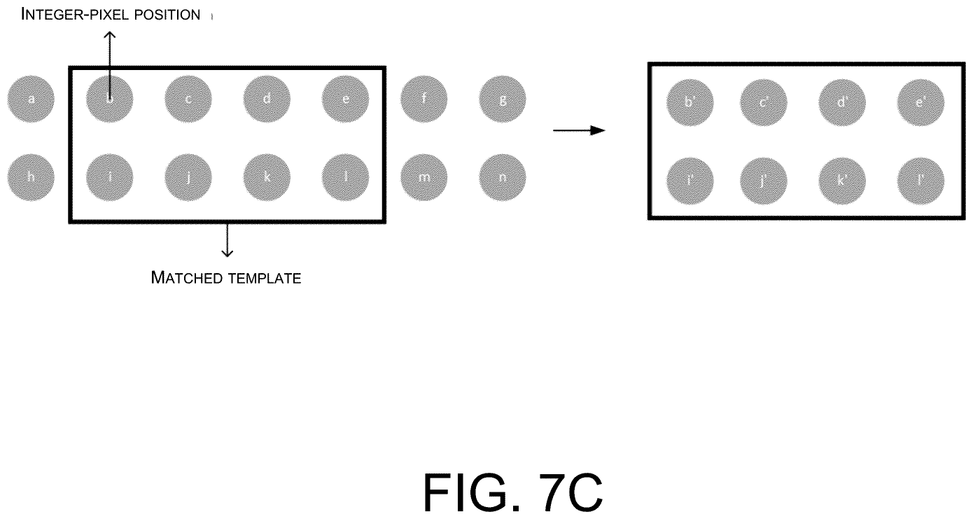

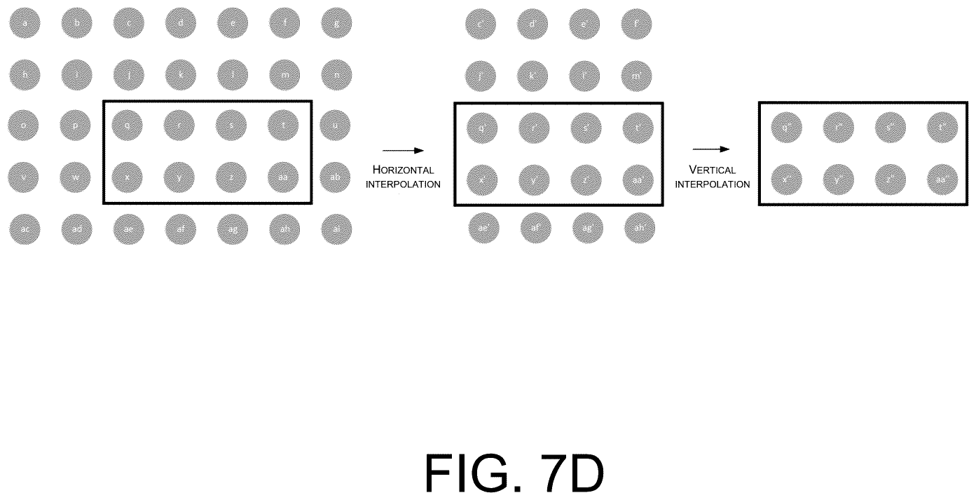

Furthermore, according to example embodiments of the present disclosure, a VVC-standard encoder and a VVC-standard decoder configure one or more processors of a computing system to refine predicted sample values of intra TMP mode by neighboring samples. For a block coded by intra TMP mode, each sample in the block can be refined using the reconstructed value of its corresponding above neighboring sample and the reconstructed value of its corresponding left neighboring sample, as shown in FIG. 7A. For example, the same method of the PDPC for planar mode can be used to refine the predicted sample values.

The usage of the refinement by the neighboring samples of intra TMP mode coded block can be indicated by a flag signaled in the bitstream. Specifically, for a block, when there is a flag in the bitstream indicating that intra TMP mode is used for the prediction, another flag is further signaled in the bitstream to indicate whether to refine by the neighboring samples. In some embodiments, there is no additional flag to indicate the refinement; that is, for a block, when there is a flag in the bitstream indicating that intra TMP mode is used for the prediction, it is always refined by the neighboring samples.

Furthermore, LIC is an inter prediction technique to model local illumination variation between current block and its prediction block as a function of that between current block template and reference block template. The parameters of the function can be denoted by a scale a and an offset β, which compensate against illumination changes according to a linear equation α*p[x]+β, where p[x] is a reference sample pointed to by MV at a location x on reference picture. When wraparound motion compensation is enabled, the MV shall be clipped with wraparound offset taken into consideration. Since a and B can be derived based on current block template and reference block template, no signaling overhead is required for them, except that a LIC flag is signaled for AMVP mode to indicate the use of LIC.

The local illumination compensation is used for uni-prediction inter CUs with the following modifications:
Intra neighbor samples can be used in LIC parameter derivation;
LIC is disabled for blocks with less than 32 luma samples;

For both non-subblock and affine modes, LIC parameter derivation is performed based on the template block samples corresponding to the current CU, instead of partial template block samples corresponding to first top-left 16×16 unit; and

Samples of the reference block template are generated by using MC with the block MV without rounding it to integer-pel position.

According to example embodiments of the present disclosure, a VVC-standard encoder and a VVC-standard decoder configure one or more processors of a computing system to perform LIC on predicted sample values of an intra TMP mode coded block. Specifically, when a block predicted by intra TMP mode finds a matching block through template matching, first, a linear model is constructed between the matched template and the template of the current block, and then, the linear model is applied to the reconstructed samples in the matching block to generate the predicted sample values of the current block instead of copying from the matching block directly.

The usage of LIC on an intra TMP mode coded block can be indicated by a flag signaled in the bitstream. Specifically, for a block, when there is a flag in the bitstream indicating that intra TMP mode is used for the prediction, another flag is further signaled in the bitstream to indicate whether to perform LIC. In some embodiments, there is no additional flag to indicate the performing of LIC: that is, for a block, when there is a flag in the bitstream indicating that intra TMP mode is used for the prediction, LIC is always performed. In some embodiments, an implicit method is used to determine whether to perform LIC on intra TMP mode coded block. This determination can be made using information of the template. For example, when the mean value of the current block template and the mean value of the matching block template have a large difference, LIC is performed; otherwise, LIC is not performed.

In some embodiments, for a block predicted by the intra TMP mode, when LIC is performed, the template matching process is also modified. First, a linear model is constructed between the template of the current block and the matched template. Then, the reconstructed values of the matched template are modified by using the linear model. Finally, the SAD value between the modified values and the reconstructed values of the template of the current block is calculated for template matching.

According to example embodiments of the present disclosure, a VVC-standard encoder and a VVC-standard decoder configure one or more processors of a computing system to implement sub-pixel positions around an integer-pixel position, or, in other words, fractional-pixel positions around an integer-pixel position, in intra TMP. By way of example, half-pixel positions (i.e., ½-pixel positions) around an integer-pixel position can be implemented in intra TMP, without limitation thereto. By way of another example, quarter-pixel positions (i.e., ¼-pixel positions) around an integer-pixel position can be implemented in intra TMP, without limitation thereto. By way of yet further examples, sub-pixel positions at further granularities around an integer-pixel position can be implemented in intra TMP.

Presently, intra TMP only supports integer-pixel precision: through template matching, a position of a block vector that indicates the position of the matching block is determined at integer-pixel precision. Then, the reconstructed values of the integer-pixel position indicated by the block vector are directly copied to the corresponding position of the current block as the predicted sample values of the current block.

According to the present disclosure, it should be understood that sub-pixel positions around an integer-pixel position supported by intra TMP mode can be represented according to coordinates along a horizontal and a vertical axis in the format (x, y) (i.e., without reference to the integer-pixel position), but can also be alternatively represented decomposed into two components: precision and direction. Sub-pixel precision should be understood as magnitude by which a sub-position is offset from an integer-pixel position, where the offset can be further decomposed into a horizontal precision offset component and a vertical precision offset component, denoted subsequently by the format (o₁, o₂). The horizontal precision offset component describes the horizontal offset of a sub-pixel position from an optimal integer-pixel position. The vertical precision offset component describes the vertical offset of that sub-pixel position from the optimal integer-pixel position. Both the horizontal precision offset and the vertical precision offset can be represented as absolute sub-pixel values (without negative values), or as sub-pixel values along a positive-negative axis centered on the optimal integer-pixel position.

Direction of “a sub-pixel position around an integer-pixel position” should be understood as one of any number of different directions of offset from an integer-pixel position, which can include eight cardinal directions, and which can further include additional intermediate directions between the cardinal directions as subsequently described.

According to one embodiment, a VVC-standard encoder and a VVC-standard decoder configure one or more processors of a computing system to determine an optimal integer-pixel position of the matching block according to intra TMP template matching, and further configure the one or more processors to subsequently decide, according to template matching the integer-pixel position against half-pixel positions around the integer-pixel position, whether to reference sub-pixel positions around the integer-pixel position for intra TMP.

According to another embodiment, a VVC-standard encoder and a VVC-standard decoder configure one or more processors of a computing system to determine the optimal integer-pixel position of the matching block according to intra TMP template matching, and further configure the one or more processors to subsequently decide, according to a syntax element signaled in the bitstream, whether to reference sub-pixel positions around the integer-pixel position for intra TMP.

The template matching process of the intra TMP is configured substantially similarly by the VVC-standard encoder and the VVC-standard decoder. However, the VVC-standard encoder further configures the signaling of syntax elements and the VVC-standard decoder is further configured by those syntax elements. A VVC-standard encoder further configures one or more processors of a computing system to, after the template matching of intra TMP determines the matching block at the optimal integer-pixel position, predict the current block by the integer-pixel position and a set of sub-pixel positions around the integer-pixel position. By way of example, template matching is performed at the top, bottom, left, and right four half-pixel positions around the integer-pixel position, respectively, and the best prediction will be determined. Then a flag that indicates whether the integer-pixel position or sub-pixel position is used is signaled in the bitstream; when the flag indicates sub-pixel position is used, another syntax element is further signaled to indicated which of a set of possible sub-pixel positions around the integer-pixel position is selected.

When predicting with the integer-pixel position, the reconstructed values of the matching block is copied to the corresponding position of the current block as the predicted sample values; when predicting with the sub-pixel position around the integer-pixel position, the matching block at the integer-pixel position will be offset according to the sub-pixel position, and the predicted sample values of the current block will be obtained through the interpolation of the matching block at the sub-pixel position around the integer-pixel position.

A VVC-standard decoder further configures one or more processors of a computing system to, for an intra TMP mode coded block, determine whether to reference the integer-pixel position or sub-pixel position by a flag signaled in the bitstream and which sub-pixel position around the integer-pixel position is used is determined by a syntax element signaled in the bitstream.

According to another embodiment, a VVC-standard encoder and a VVC-standard decoder configure one or more processors of a computing system to determine the optimal integer-pixel position of the matching block through template matching, and further configure the one or more processors to decide, according to a flag signaled in the bitstream and according to the template, whether to reference sub-pixel positions around the integer-pixel position for intra TMP.

A VVC-standard encoder further configures one or more processors of a computing system to, after the template matching of intra TMP determines the matching block at the optimal integer-pixel position, predict the current block by the integer-pixel position and a set of sub-pixel positions around the integer-pixel position. By way of example, template matching is performed at one of the top, bottom, left, and right four half-pixel positions around the integer-pixel position, respectively, and the best prediction will be determined. Then a flag that indicates whether the integer-pixel position or sub-pixel position is used will be signaled in the bitstream.

A VVC-standard decoder further configures one or more processors of a computing system to, for an intra TMP mode coded block, determine whether to reference the integer-pixel position or sub-pixel position by a flag signaled in the bitstream. A coordinate of the half-pel position is determined by the template at both encoder and decoder in the same way.

According to some embodiments, a high-level syntax structure flag is signaled to indicate whether sub-pixel positions are supported to intra TMP: for example, the flag can be signaled in a SPS syntax structure found in a sequence of multiple pictures, as described above. Based on this high-level flag, it is possible to enable sub-pixel positions only in certain cases. For example, for camera-captured contents, this flag is set to true, configuring intra TMP to support sub-pixel positions for camera-captured contents; while for screen contents, this flag is set to false, configure intra TMP to not support sub-pixel positions for screen contents.

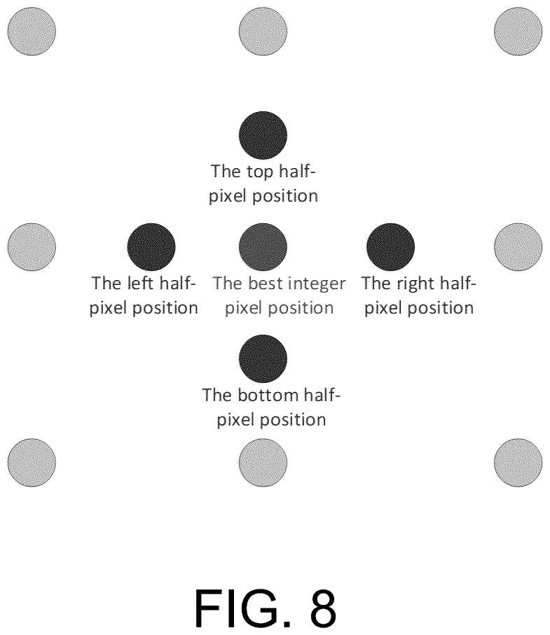

After the template matching of intra TMP determines the matching block at the optimal integer-pixel position, and sub-pixel positions around the integer-pixel position are to be referenced (regardless of how the one or more processors decide that they are to be referenced), the one or more processors continue to perform template matching at a set of sub-pixel positions around the integer-pixel position. By way of example, template matching is performed at the top, bottom, left, and right four half-pixel positions around the integer-pixel position. FIG. 8 illustrates the top, bottom, left, and right half-pixel positions around the integer-pixel position.

When template matching is performed on sub-pixel positions around the integer-pixel position, for each of a set of sub-pixel positions around the integer-pixel position, an interpolation filter is used to interpolate the matched template, and then the SAD between the interpolated matched template and each of a set of sub-pixel positions around the integer-pixel position is calculated.

Interpolating a matched template should be understood as, for each sample of the matched template, inputting that sample and some neighboring samples into an interpolation filter to output a respective interpolated sample. In other words, all samples of the matched template, and some neighboring samples, are input into an interpolation filter to output interpolated samples for the entire matched template.

The present disclosure does not specifically limit the type and the number of taps of the interpolation filter used for matched template interpolation.

In any direction of the matched template (above, below, left, and right), from 0 to 2 lines of neighboring samples can be input into the interpolation filter. Furthermore, neighboring samples can be biased towards a direction of offset from the integer-pixel position to a sub-pixel position.

By way of example, the matched template of FIG. 7B can be interpolated as follows: for a sub-pixel position offset left of the integer-pixel position, and for a 4-tap interpolation filter, samples a to n as illustrated in FIG. 7B are input to the interpolation filter, where, to output each individual sample, left-biased neighboring samples of that individual sample are input to the interpolation filter. In other words, to output sample c′, left-biased samples a, b, c and d are input to the interpolation filter; to output sample d′, left-biased samples b, c, d and e are input to the interpolation filter; to output sample m′, left-biased samples k, l, m and n are input to the interpolation filter; and so forth.

By way of another example, the matched template of FIG. 7C can be interpolated as follows: for a sub-pixel position offset right of the integer-pixel position, and for a 4-tap interpolation filter, samples a to n as illustrated in FIG. 7C are input to the interpolation filter, where, to output each individual sample, right-biased neighboring samples of that individual sample are input to the interpolation filter. In other words, to output sample b′, right-biased samples a, b, c and d are input to the interpolation filter; to output sample c′, right-biased samples b, c, d and e are input to the interpolation filter; to output sample l′, right-biased samples k, l, m and n are input to the interpolation filter; and so forth.

By way of another example, the matched template of FIG. 7D can be interpolated as follows: for a sub-pixel position offset upper-left of the integer-pixel position, and for a 4-tap interpolation filter, samples a to ai as illustrated in FIG. 7D are input first to a horizontal interpolation filter, where, to output each individual sample, left-biased neighboring samples of that individual sample are input to the interpolation filter. This outputs samples c′ to ah′, which are in turn input to a vertical interpolation filter, where, to output each individual sample, upper-biased neighboring samples of that individual sample are input to the interpolation filter.

In other words, to output sample c′, left-biased samples a, b, c and d are input to the interpolation filter; to output sample j′, left-biased samples h, i, j and k are input to the interpolation filter; to output sample q′, left-biased samples o, p, q and r are input to the interpolation filter; to output sample x′, left-biased samples v, w, x and y are input to the interpolation filter; and so forth. Then, to output sample q′, upper-biased samples c′, j′, q′ and x′ are input to the interpolation filter, and so forth.

If at least one of the SAD values of the set of sub-pixel positions around the integer-pixel position is smaller than the SAD value of the optimal integer-pixel position, sub-pixel positions are used. Among the set of sub-pixel positions around the integer-pixel position, the sub-pixel position with the smallest SAD value is determined for motion prediction. When predicting, the matching block at the integer-pixel position will be offset according to the determined sub-pixel position, and the predicted sample values of the current block will be obtained through interpolation of the matching block at the determined sub-pixel position around the integer-pixel position.

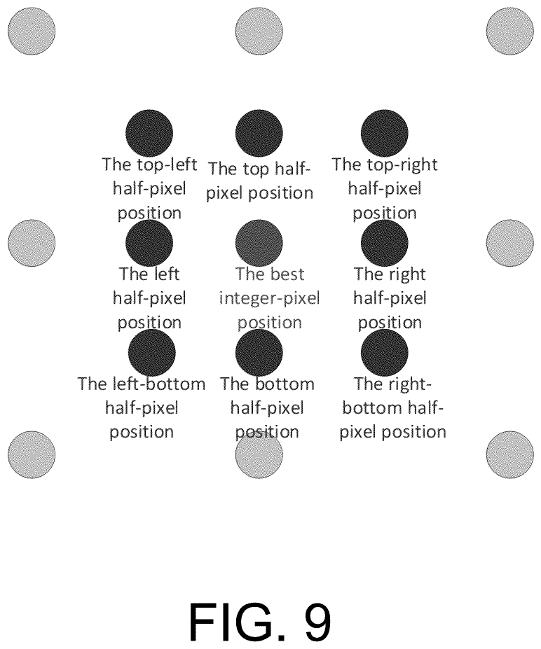

According to some embodiments, the positions of the sub-pixel can be the eight positions relative to an optimal integer-pixel position as shown in FIG. 9: the top half-pixel position, the bottom half-pixel position, the left half-pixel position, the right half-pixel position, the top-left half-pixel position, the top-right half-pixel position, the bottom-left half-pixel position and the bottom-right half-pixel position relative to the optimal integer-pixel position. For the four half-pixel positions in the diagonal directions, the interpolation in the horizontal and vertical directions can be performed respectively when interpolating. By way of example, the interpolation in the horizontal direction is performed first, and then the interpolation in the vertical direction is performed. By way of another example, the interpolation in the vertical direction is performed first, and then the interpolation in the horizontal direction is performed.

In terms of precision and direction, each of the above eight positions is offset by a half-pixel position from the optimal integer-pixel position, and each is offset by a different direction among eight directions from the optimal integer-pixel position.

According to some embodiments, not only the half-pixel position can be considered in intra TMP, but also other sub-pixel positions, such as ¼-pixel position, ⅛-pixel position and 1/16-pixel positions. The interpolation filter coefficients can be different for different levels of precision.

According to further embodiments, sub-pixel positions of multiple, different precisions can be implemented in combination in intra TMP. That is, different combinations of sub-pixel precisions and directions can be supported in intra TMP.

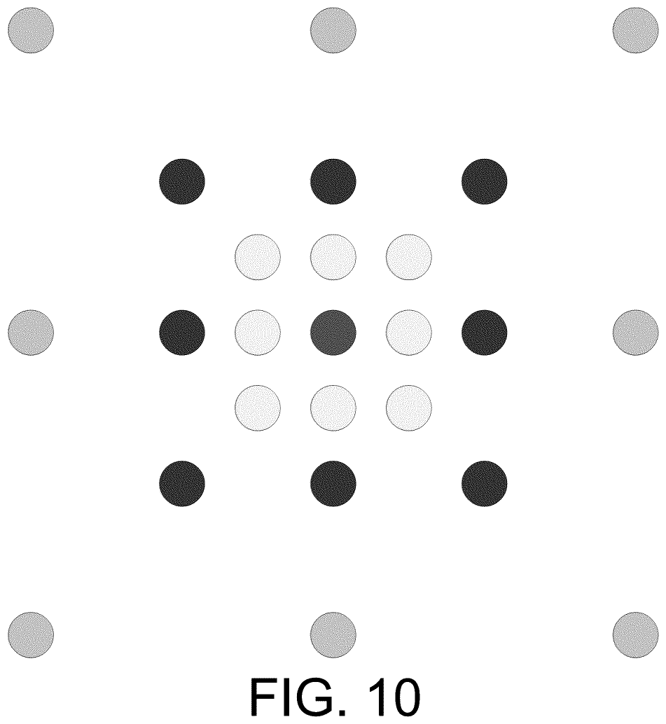

Combinations selected from two sub-pixel precisions and eight directions can be supported in intra TMP. By way of example, ½-pixel precision and ¼-pixel precision are supported, and for each precision eight directions are supported as shown in FIG. 10, which illustrates sixteen sub-pixel positions in total in eight directions. The blue circle indicates an integer pixel position, the grey circles indicate the neighboring integer pixel positions, the red circles indicate the ½-pixel precision positions in eight directions, and the yellow circles indicate the ¼-pixel precision positions in eight directions.

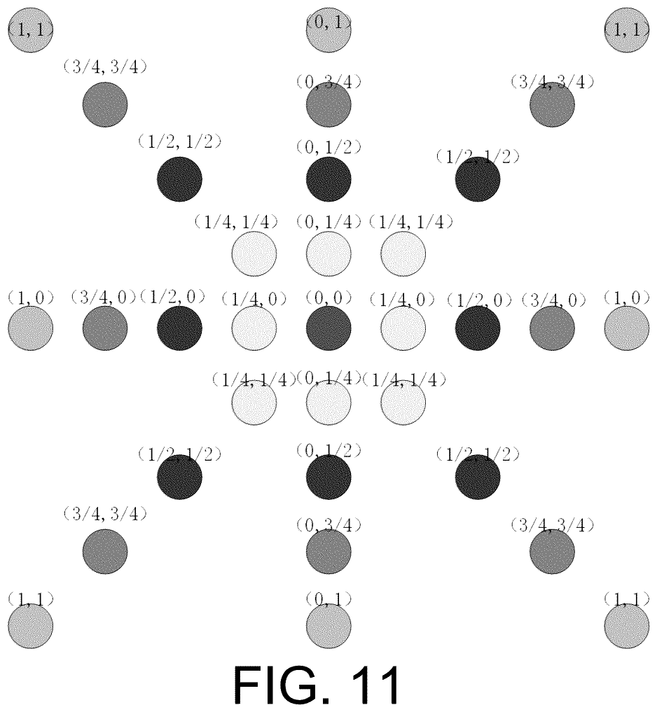

Alternatively, combinations selected from three sub-pixel precisions and eight directions can be supported in intra TMP. By way of example, ½-pixel precision, ¼-pixel precision and ¾-pixel precision are supported, and for each precision eight directions are supported as shown in FIG. 11, which illustrates twenty-four sub-pixel positions in total in eight directions. The blue circle indicates an integer pixel position, the grey circles indicate the neighboring integer pixel positions, the red circles indicate the ½-pixel precision positions in eight directions, the yellow circles indicate the ¼-pixel precision positions in eight directions, and the green circles indicate the ¾-pixel precision positions in eight directions.

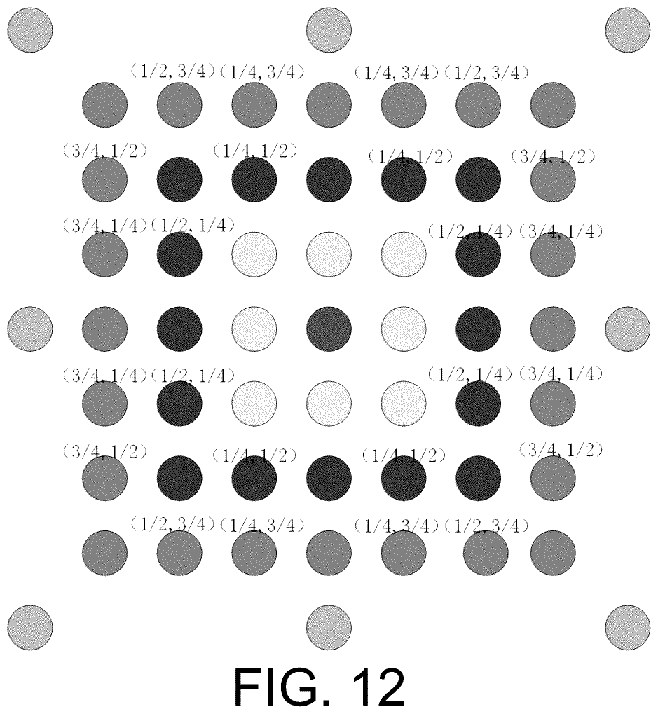

Alternatively, a combination of three sub-pixel precisions and up to twenty-four directions can be supported in intra TMP, with additional directions beyond the eight cardinal directions supported due to sub-pixel granularity. By way of example, ½-pixel precision, ¼-pixel precision and ¾-pixel precision are supported; for ¼-pixel precision eight directions are supported, for ½-pixel precision a greater granularity of sixteen directions are supported, and for ¾-pixel precision a still greater granularity of twenty-four directions are supported as shown in FIG. 12, which illustrates forty-eight sub-pixel positions. The blue circle indicates an integer pixel position, the grey circles indicate the neighboring integer pixel positions, the red circles indicate the ½-pixel precision positions in sixteen directions, the yellow circles indicate the ¼-pixel precision positions in eight directions, and the green circles indicate the ¾-pixel precision positions in twenty-four directions.

FIGS. 11 and 12 further illustrate each sub-pixel position with a coordinate position decomposed into a horizontal offset component and a vertical offset component (o₁, o₂) as described above (using absolute values); a direction component as described above is not illustrated. As illustrated in FIG. 11, those sub-pixel positions in cardinal directions from the optimal integer-pixel position have integer-pixel precision along one of two offsets, while those sub-pixel positions in ordinal directions from the optimal integer-pixel position have sub-pixel precisions along both offsets, where both sub-pixel precisions have the same magnitude. As illustrated in FIG. 12, the additional sub-pixel positions are intermediate to the cardinal directions and the ordinal directions; these intermediate sub-pixel positions have different sub-pixel precisions along both offsets.

The proposed multiple sub-pixel precision and direction decompositions can be combined with the aforementioned embodiments.

In some embodiments, both the sub-pixel precision and direction are derived by template matching configured substantially similarly by the VVC-standard encoder and the VVC-standard decoder. By way of example, where intra TMP is implemented with ½-pixel precision, ¼-pixel precision and ¾-pixel precision with eight directions are supported (as illustrated in FIG. 11), and after the optimal integer-pixel position of the matching block through template matching according to intra TMP, a further determination is made whether to reference sub-pixel positions around the integer-pixel position and which sub-pixel position (which precision and which direction) is used according to the template. That is, the position with the smallest template SAD value is used.

In some embodiments, both the sub-pixel precision and direction are indicated by syntax elements signaled in a bitstream. A flag is first signaled to indicate whether to reference the best integer-pixel position derived by template matching or sub-pixel position around the integer-pixel position. If the flag indicates one of the sub-pixel positions is used, one or more syntax elements are further signaled to indicate which one of the sub-pixel positions around the integer-pixel position is used. By way of one example, a sub-pixel position is signaled by one syntax element. By way of another example, the selected precision is signaled by a syntax element first, and then the selected direction is signaled by another syntax element. By way of yet another example, the selected direction is signaled by a syntax element first, and then the selected precision is signaled by another syntax element. Each of the mentioned syntax elements can be signaled by fixed-length coding or truncated unary coding or truncated binary coding or exponential-golomb coding or any other binarization coding method.

In some embodiments, the sub-pixel precision is indicated by a syntax element signaled in a bitstream; the direction is not signaled in a bitstream; and an encoder and a decoder are each configured to derive the direction by template matching. That is, if a flag indicates one of the sub-pixel positions is used, a syntax element is further signaled to indicate which sub-pixel precision is selected. Then, template matching is performed in the supported directions with the selected precision, and the direction with the smallest SAD value is selected.

In some embodiments, the direction is indicated by a syntax element signaled in a bitstream; the sub-pixel precision is not signaled in a bitstream; and an encoder and a decoder are each configured to derive the sub-pixel precision by template matching. That is, if a flag indicates one of the sub-pixel positions is used, a syntax element is further signaled to indicate which direction is selected. Then, template matching is performed in the direction with supported precisions, and the precision with the smallest SAD value is selected.

In some embodiments, the sub-pixel precision is indicated by a syntax element signaled in a bitstream; the direction is not signaled in a bitstream; and the direction is derived by a syntax element signaled in a bitstream and a template matching method. That is, if a flag indicates one of the sub-pixel positions is used, a syntax element is further signaled to indicate which sub-pixel precision is selected. Then the supported directions can be divided into C categories, and another syntax element is further signaled to indicate which category of directions is selected. The value of C should be smaller than the number of the supported directions, and each category should have at least one direction. For the selected category of directions, if there are more than one directions, template matching is performed in these directions with the selected precision, and the direction with the smallest SAD value is selected.

By way of example, where intra TMP is implemented with ½-pixel precision, ¼-pixel precision and ¾-pixel precision with eight directions are supported (as illustrated in FIG. 11), a syntax element is signaled to indicate which of the three sub-pixel precision is selected. Furthermore, the eight directions can be divided into four categories: {top, bottom}, {left, right}, {top-left, right-bottom} and {top-right, left-bottom} (that is, every two opposite directions are classified into the same category), and another syntax element is further signaled to indicate which category of directions is selected. For the two opposite directions in this category, template matching is performed with the selected precision to select one direction.

In some embodiments, when selecting one direction in a category by template matching, the template matching can be performed in the directions in the category with a fixed precision, instead of using the selected precision. By way of example, no matter which precision is selected, the template matching is performed with ½-pixel precision when selecting one direction in a category by template matching.

In some embodiments, for each intra TMP-coded block, if one of the sub-pixel positions is selected, a template matching is used to reorder the sub-pixel positions list.

By way of one example, all the sub-pel positions are sorted by template matching based on the SAD values. Then, the best N positions are used to construct a sub-pixel positions list, and an index is signaled to indicate which sub-pixel position is selected to predict the current block. The value of N can be any positive integers less than or equal to the number of the supported sub-pixel positions. For example, as for the supported sub-pixel positions according to FIG. 11, N is less than or equal to 24.

By way of another example, only the sub-pel precisions are sorted by template matching based on the SAD values. A direction can be decided by a syntax element, then the sub-pel precisions in this direction are sorted by template matching based on the SAD values and the best P precisions are used to construct a sub-pixel precisions list, and an index is signaled to indicate which sub-pixel precision is selected. The value of P can be any positive integers less than or equal to the number of the supported sub-pixel precisions in this direction. For example, as for the supported sub-pixel positions according to FIG. 11, P is less than or equal to 3.

By way of yet another example, only the sub-pel directions are sorted by template matching based on the SAD values. A precision can be decided by a syntax element signaled in the bitstream, then the sub-pel directions with this precision are sorted by template matching based on the SAD values and the best D directions are used to construct a sub-pixel directions list, and an index is signaled to indicate which sub-pixel direction is selected. The value of D can be any positive integers less than or equal to the number of the supported sub-pixel directions with this precision. For example, as for the supported sub-pixel positions related to FIG. 11, D is less than or equal to 8. In some embodiments, the same sub-pixel directions list can be used for each precision, and the list can be derived with a certain precision. For example, as for the supported sub-pixel positions related to FIG. 11, a sub-pixel directions list is constructed with ½-pixel precision, and can be used for ¼-pixel precision and 4/3-pixel precision.

All the mentioned indexes can be signaled by fixed-length coding or truncated unary coding or truncated binary coding or exponential-golomb coding or other binarization coding method.

In some embodiments, the template matching cost can be Sum of Absolute Transformed Difference (“SATD”), so that the above-mentioned SAD cost function can be replaced by a SATD cost function.

The present disclosure does not specifically limit the type and the number of taps of the interpolation filter used for half-pixel interpolation.

For horizontal half-pixel interpolation, by way of example, a two-tap interpolation filter [32 32] can be used. By way of another example, a 4-tap DCT-IF interpolation filter [−4 36 36−4] can be used. By way of another example, a 4-tap DCT-IF interpolation filter [−16 144 144−16] can be used. By way of another example, a 4-tap weak DCT-IF interpolation filter [−5 37 37−5] can be used. By way of another example, a 4-tap Gaussian interpolation filter [8 24 24 8] can be used. By way of another example, a 6-tap flat interpolation filter [3 9 20 20 9 3] can be used. By way of another example, a 6-tap DCT-IF interpolation filter [12−44 160 160−44 12] can be used. By way of another example, an 8-tap DCT-IF interpolation filter [−4 16−44 160 160−44 16−4] can be used. By way of another example, a 12-tap DCT-IF interpolation filter [−2 6−13 25−50 162 162−50 25−13 6−2] can be used. For vertical half-pixel interpolation, the interpolation filter is a transposition of the interpolation filter for horizontal half-pixel interpolation filter.

For horizontal quarter-pixel interpolation in right direction (when the quarter-pixel position is in the right of the optimal integer-pixel position), by way of example, a two-tap bilinear interpolation filter [48 16] can be used. By way of another example, a 4-tap DCT-IF interpolation filter [−16 216 64−8] can be used. By way of another example, a 6-tap DCT-IF interpolation filter [12−40 232 68−20 4] can be used. By way of another example, an 8-tap DCT-IF interpolation filter [−4 16−40 323 68−20 4 0] can be used. By way of another example, a 12-tap DCT-IF interpolation filter [−2 5−11 21−43 230 75−29 15−8 4−1] can be used. For horizontal quarter-pixel interpolation in left direction (when the quarter-pixel position is in the left of the optimal integer-pixel position), the interpolation filter is a horizontal flip of the interpolation filter for horizontal quarter-pixel in right direction. For vertical quarter-pixel interpolation in top direction (when the quarter-pixel position is in the top of the optimal integer-pixel position), the interpolation filter is a transposition of the interpolation filter for horizontal quarter-pixel interpolation in left direction. For vertical quarter-pixel interpolation in bottom direction (when the quarter-pixel position is in the bottom of the optimal integer-pixel position), the interpolation filter is a transposition of the interpolation filter for horizontal quarter-pixel interpolation in right direction.

For horizontal three-quarters-pixel interpolation, the interpolation filter is a horizontal flip of the interpolation filter for horizontal quarter-pixel interpolation; and for vertical three-quarters-pixel interpolation, the interpolation filter is a vertical flip of the interpolation filter for horizontal quarter-pixel interpolation.

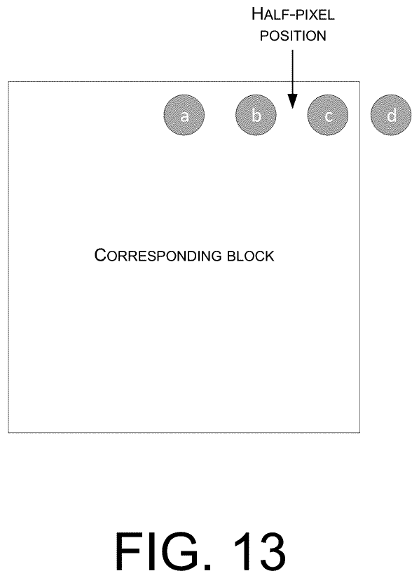

Interpolation is performed using the neighboring samples adjacent to the current block. According to some embodiments, when sub-pixel interpolation is performed on a matching block (as defined above with reference to intra TMP techniques), and at least one sample outside the matching block is input into an interpolation filter, the input sample outside the matching block will be padded by copying the closest reconstructed sample in the matching block. By way of example, as shown in FIG. 13, the half-pixel position is used; the half-pixel position is between sample b and sample c; a 4-tap interpolation filter is used for interpolation; and input sample a, input sample b, input sample c, and input sample d are each input into the interpolation filter. The input sample d is outside the matching block, so the input sample c, which is the closest reconstructed sample to the input sample d within the matching block, is used for padding: the value of the input sample c is copied to the input sample d.

According to some embodiments, padding is only performed on the input sample outside the matching block in the interpolation process when that input sample is not available. In the event that the matching block is at a boundary of a picture, slice, or tile, adjacent samples on an entire side may not exist. Furthermore, even if upper-adjacent and left-adjacent samples have been encoded or decoded before the matching block, right-adjacent and lower-adjacent samples may not be encoded or decoded before the current coding block according to raster scanning order. Other possible coding orders may also change the availability of adjacent samples at the entirety of a upper, left, right, or lower edge. Thus, the present disclosure will refer to nonexistent or non-encoded and non-decoded adjacent samples along an edge as “not available.” For example, as shown in FIG. 13, if the input sample d is available, there is no padding; if the input sample d is not available, it will be padded by copying input sample c.

According to some embodiments, when determining the half-pixel positions, half-pixel positions in addition to those directly adjacent to the optimal integer pixel are considered. For example, all sub-pixel positions within an area around the optimal integer pixel can be considered. The range of the area can be related to the width and height of the current block.

By way of example, all half-pixel positions within the range of no more than 2 integer pixels from the best integer pixel position obtained by template matching are supported. Therefore, the ½-pixel position and 3/2-pixel positions are supported.

In some embodiments, the integer-pixel positions within an area around the optimal integer pixel position can also be considered. In some embodiments, a syntax element is firstly signaled to indicate which integer pixel position within an area around the optimal integer pixel position is selected, then another syntax element is further signaled to indicate which sub-pixel position around the integer pixel position is used.

The proposed sub-pixel position based intra TMP can be combined with other intra TMP tools.

In some embodiments, when combined with multi-candidate intra TMP, the sub-pixel position based intra TMP and multi-candidate intra TMP are treated as two separate schemas. That is, the multi-candidate index is only signaled when integer-pixel position is used; or a flag is firstly signaled to indicate whether the multi-candidate method is used or not, and only when the multi-candidate method is not used, the sub-pixel position based intra TMP method can be used.

In some embodiments, when combined with multi-candidate intra TMP, if multi-candidate intra TMP is used, then after signaling the multi-candidate index, the sub-pixel position related parameters that indicates the sub-pixel position are further signaled or derived by template matching.

In some embodiments, when combined with intra TMP fusion, the sub-pixel position based intra TMP and intra TMP fusion are treated as two separate schemas. That is, the fusion method is only signaled when integer-pixel position is used; or the sub-pixel position based intra TMP method is only signaled when intra TMP fusion is not used.

In some embodiments, when combined with intra TMP fusion, the sub-pixel position related parameters that indicates the sub-pixel position for each matching block used in fusion method are signaled or derived by template matching. In some embodiments, the same sub-pixel position is used for all matching blocks used in fusion method.

In some embodiments, when combined with intra TMP filter, the sub-pixel position based intra TMP and intra TMP filter are treated as two separate schemas. That is, the filter method is only signaled when integer-pixel position is used; or the sub-pixel position based intra TMP method is only signaled when intra TMP filter is not used.

In some embodiments, when combined with intra TMP filter, if intra TMP filter is used, then the sub-pixel position related parameters that indicates the sub-pixel position are further signaled or derived by template matching. In some embodiments, the filter process is performed after sub-pixel position interpolation; and in some embodiments, the filter process is performed before sub-pixel position interpolation.

In some embodiments, when combined with left template only intra TMP or above template only intra TMP, the sub-pixel position based intra TMP and intra TMP with multiple modes are treated as two separate schemas. That is, the left template only intra TMP or above template only intra TMP is only signaled when integer-pixel position is used; or the sub-pixel position based intra TMP method is only signaled when L-shaped template intra TMP is used.

In some embodiments, when combined with left template only intra TMP or above template only intra TMP, if left template only intra TMP or above template only intra TMP, then the sub-pixel position related parameters that indicates the sub-pixel position are further signaled or derived by template matching.

In some embodiment, the methods mentioned above for intra TMP can be used in IBC.

Moreover, according to example embodiments of the present disclosure, a VVC-standard encoder and a VVC-standard decoder configure one or more processors of a computing system to perform intra TMP mode according to one of two flip modes: horizontal flip mode and vertical flip mode.

For a horizontal flip mode, when performing the template matching, only the top template is used. Before performing template matching, the top template of the current block is first horizontally flipped, and then the template matching process is performed to find a template that matches the horizontally flipped top template. Subsequently, the corresponding matching block will be flipped horizontally, and then used as the predicted sample values of the current block.

For a vertical flip mode, when performing the template matching, only the left template is used. Before performing template matching, the left template of the current block is first vertically flipped, and then the template matching process is performed to find a template that matches the vertically flipped left template. Subsequently, the corresponding matching block will be flipped vertically, and then used as the predicted sample values of the current block.

According to another embodiment, different flipping methods are implemented, as follows.

For a horizontal flip mode, when performing the template matching, only the top template is used. Before performing template matching, the top template of the current block is first horizontally flipped, and then the template matching process is performed to find a template that matches the horizontally flipped top template. A VVC-standard encoder further configures one or more processors of a computing system to, before calculating the residue between the original values and the predicted sample values of the current block, horizontally flip the original values of the current block. After reconstruction of the current block, the reconstructed values are horizontally flipped.

For a vertical flip mode, when performing the template matching, only the left template is used. Before performing template matching, the left template of the current block is first vertically flipped, and then the template matching process is performed to find a template that matches the vertically flipped left template. A VVC-standard encoder further configures one or more processors of a computing system to, before calculating the residue between the original values and the predicted sample values of the current block, vertically flip the original values of the current block. After reconstruction of the current block, the reconstructed values are vertically flipped.

The performance of flipping upon an intra TMP mode-coded block can be indicated by a flag signaled in the bitstream. Specifically, for a block, when there is a flag in the bitstream indicating that intra TMP mode is used for the prediction, another flag is further signaled in the bitstream to indicate whether to perform flipping. Then, another flag is signaled to indicates which of the horizontal flip or vertical flip is selected.

Persons skilled in the art will appreciate that all of the above aspects of the present disclosure may be implemented concurrently in any combination thereof, and all aspects of the present disclosure may be implemented in combination as yet another embodiment of the present disclosure.

FIG. 14 illustrates an example system 1400 for implementing the processes and methods described above for implementing intra template matching prediction mode.

The techniques and mechanisms described herein may be implemented by multiple instances of the system 1400 as well as by any other computing device, system, and/or environment. The system 1400 shown in FIG. 14 is only one example of a system and is not intended to suggest any limitation as to the scope of use or functionality of any computing device utilized to perform the processes and/or procedures described above. Other well-known computing devices, systems, environments and/or configurations that may be suitable for use with the embodiments include, but are not limited to, personal computers, server computers, hand-held or laptop devices, multiprocessor systems, microprocessor-based systems, set top boxes, game consoles, programmable consumer electronics, network PCs, minicomputers, mainframe computers, distributed computing environments that include any of the above systems or devices, implementations using field programmable gate arrays (“FPGAs”) and application specific integrated circuits (“ASICs”), and/or the like.

The system 1400 may include one or more processors 1402 and system memory 1404 communicatively coupled to the processor(s) 1402. The processor(s) 1402 may execute one or more modules and/or processes to cause the processor(s) 1002 to perform a variety of functions. In some embodiments, the processor(s) 1402 may include a central processing unit (“CPU”), a graphics processing unit (“GPU”), both CPU and GPU, or other processing units or components known in the art. Additionally, each of the processor(s) 1402 may possess its own local memory, which also may store program modules, program data, and/or one or more operating systems.

Depending on the exact configuration and type of the system 1400, the system memory 1404 may be volatile, such as RAM, non-volatile, such as ROM, flash memory, miniature hard drive, memory card, and the like, or some combination thereof. The system memory 1404 may include one or more computer-executable modules 1406 that are executable by the processor(s) 1402.

The modules 1406 may include, but are not limited to, one or more of an encoder 1408 and a decoder 1410.

The encoder 1408 may be a VVC-standard encoder implementing any, some, or all aspects of example embodiments of the present disclosure as described above, and executable by the processor(s) 1402 to configure the processor(s) 1402 to perform operations as described above.

The decoder 1410 may be a VVC-standard encoder implementing any, some, or all aspects of example embodiments of the present disclosure as described above, executable by the processor(s) 1402 to configure the processor(s) 1402 to perform operations as described above.

The system 1400 may additionally include an input/output (“I/O”) interface 1440 for receiving image source data and bitstream data, and for outputting reconstructed pictures into a reference picture buffer or DPB and/or a display buffer. The system 1400 may also include a communication module 1450 allowing the system 1400 to communicate with other devices (not shown) over a network (not shown). The network may include the Internet, wired media such as a wired network or direct-wired connections, and wireless media such as acoustic, radio frequency (“RF”), infrared, and other wireless media.

Some or all operations of the methods described above can be performed by execution of computer-readable instructions stored on a computer-readable storage medium, as defined below. The term “computer-readable instructions” as used in the description and claims, include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

The computer-readable storage media may include volatile memory (such as random-access memory (“RAM”)) and/or non-volatile memory (such as read-only memory (“ROM”), flash memory, etc.). The computer-readable storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transient or non-transitory computer-readable storage medium is an example of computer-readable media. Computer-readable media includes at least two types of computer-readable media, namely computer-readable storage media and communications media. Computer-readable storage media includes volatile and non-volatile, removable and non-removable media implemented in any process or technology for storage of information such as computer-readable instructions, data structures, program modules, or other data. Computer-readable storage media includes, but is not limited to, phase change memory (“PRAM”), static random-access memory (“SRAM”), dynamic random-access memory (“DRAM”), other types of random-access memory (“RAM”), read-only memory (“ROM”), electrically erasable programmable read-only memory (“EEPROM”), flash memory or other memory technology, compact disk read-only memory (“CD-ROM”), digital versatile disks (“DVD”) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. A computer-readable storage medium employed herein shall not be interpreted as a transitory signal itself, such as a radio wave or other free-propagating electromagnetic wave, electromagnetic waves propagating through a waveguide or other transmission medium (such as light pulses through a fiber optic cable), or electrical signals propagating through a wire.

The computer-readable instructions stored on one or more non-transient or non-transitory computer-readable storage media that, when executed by one or more processors, may perform operations described above with reference to FIGS. 1A-10. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A computing system, comprising:
one or more processors, and
a computer-readable storage medium communicatively coupled to the one or more processors, the computer-readable storage medium storing computer-readable instructions executable by the one or more processors that, when executed by the one or more processors, perform associated operations comprising:
matching a template of a current block to a template in a searched region;
determining an integer-pixel position of a block vector of a matching block corresponding to the matched template;
determining a sub-pixel position around the integer-pixel position; and
deriving reconstructed values of the matching block at the determined sub-pixel position around the integer-pixel position as predicted sample values of the current block.

2. The computing system of claim 1, wherein the one or more processors are configured to derive reconstructed values of the matching block at the determined sub-pixel position by applying an interpolation filter.

3. The computing system of claim 2, wherein the one or more processors are configured to interpolate reconstructed values of the matching block at a half-pixel position by applying a 4-tap DCT-IF interpolation filter [−16 144 144−16].

4. The computing system of claim 2, wherein the one or more processors are configured to interpolate reconstructed values of the matching block at a quarter-pixel position by applying a 4-tap DCT-IF interpolation filter [−16 216 64−8].

5. The computing system of claim 2, wherein the one or more processors are configured to pad an input sample which is not available by copying a closest reconstructed sample in the matching block.

6. The computing system of claim 1, wherein a sub-pixel position around the integer-pixel position comprises a precision and a direction;
wherein the precision comprises a magnitude of an offset from the integer-pixel position; and
wherein the direction comprises one of a plurality of cardinal directions from the integer-pixel position.

7. The computing system of claim 6, wherein a set of sub-pixel positions around the integer-pixel position comprises twenty-four combinations of precision and direction, each precision selected from three sub-pixel precisions and each direction selected from eight cardinal directions.

8. The computing system of claim 7, wherein the three sub-pixel precisions comprise ¼-pixel precision, ½-pixel precision, and ¾-pixel precision.

9. The computing system of claim 1, wherein the one or more processors are configured to template match the integer-pixel position against sub-pixel positions around the integer-pixel position by interpolating the matched template for each respective sub-pixel position.

10. The computing system of claim 1, wherein the one or more processors are further configured to transmit, in a bitstream, a first flag indicating to reference a sub-pixel position around an integer-pixel position for intra template matching prediction (“intra TMP”).

11. The computing system of claim 10, wherein the one or more processors are further configured to transmit, in a bitstream, a second flag indicating one among a set of sub-pixel positions around the integer-pixel position.

12. The computing system of claim 11, wherein the one or more processors are configured to transmit the one among the set of sub-pixel positions in a syntax element of the bitstream.

13. The computing system of claim 11, wherein the one or more processors are configured to transmit a precision of the one among the set of sub-pixel positions in a first syntax element of the bitstream, and to transmit a direction of the one among the set of sub-pixel positions in a second syntax element of the bitstream trailing the first syntax element.

14. The computing system of claim 11, wherein the one or more processors are configured to transmit a direction of the one among the set of sub-pixel positions in a first syntax element of the bitstream, and to transmit a precision of the one among the set of sub-pixel positions in a second syntax element of the bitstream trailing the first syntax element.

15. The computing system of claim 11, wherein the one or more processors are configured to transmit the one among the set of sub-pixel positions according to binarization coding selected from one of fixed-length coding, truncated unary coding, truncated binary coding, and exponential-golomb coding.

16. The computing system of claim 1, wherein the one or more processors are further configured to read a first flag from a bitstream; and
the one or more processors are configured to interpolate reconstructed values of the matching block at the determined sub-pixel position around the integer-pixel position as predicted sample values of the current block based on the first flag.

17. The computing system of claim 16, wherein the one or more processors are configured to read a second flag from the bitstream; and
the one or more processors are configured to determine the sub-pixel position around the integer-pixel position based on the second flag indicating the sub-pixel position around the integer-pixel position.

18. A non-transitory computer-readable storage medium storing a bitstream associated with one or more pictures, the bitstream comprising a first flag indicating to reference a sub-pixel position around an integer-pixel position for intra template matching prediction (“intra TMP”).

19. The non-transitory computer-readable storage medium of claim 18, wherein the bitstream further comprises a second flag indicating one among a set of sub-pixel positions around the integer-pixel position.

20. The non-transitory computer-readable storage medium of claim 19, wherein the bitstream further comprises a first syntax element and a second syntax element trailing the first syntax element; and
wherein the first syntax element comprises a precision of the one among the set of sub-pixel positions and the second syntax element comprises a direction of the one among the set of sub-pixel positions, or the first syntax element comprises the direction and the second syntax element comprises the precision.
